(19) United States
(12) Patent Application Publication
(10) Pub. No.: US 2014/0086328 A1
(43) Pub. Date: Mar. 27, 2014

(54) SCALABLE VIDEO CODING IN HEVC

(71) Applicant: QUALCOMM Incorporated, San Diego, CA (US)

(72) Inventors: Ying Chen, San Diego, CA (US); Marta Karczewicz, San Diego, CA (US)

(73) Assignee: QUALCOMM Incorporated, San Diego, CA (US)

(21) Appl. No.: 14/035,754

(22) Filed: Sep. 24, 2013

Related U.S. Application Data
(60) Provisional application No. 61/705,579, filed on Sep. 25, 2012.

(51) Int. Cl. H04N 7/26

(52) U.S. Cl. CPC H04N 19/0043
USPC 375/240.16

(57) ABSTRACT

In one example, a device includes a video coder configured to determine a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor, and restrict the temporal motion vector prediction process such that the co-located picture used to derive the temporal motion vector predictor is not located in a layer other than the first layer of the plurality of layers of video data.

This application claims the benefit of U.S. Provisional Patent Application No. 61/705,579, filed on Sep. 25, 2012, the entire content of which is hereby incorporated by reference herein.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, such as Scalable Video Coding (SVC) and Multiview Video Coding (MVC). Version 8 of the Working Draft (WD) of HEVC is available from http://phenix.int-evry.fr/jct/doc_end_user/documents/10_Stockholm/wg11/JCTVC-J1003-v8.zip. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for coding motion vectors, including determining a temporal motion vector predictor (TMVP) for coding motion vectors. For example, aspects of this disclosure include restricting a temporal motion vector prediction process, such that a TMVP from one layer of multilayer video data is not used to predict a motion vector of a block in another, different layer of the multilayer video data. The techniques may prevent a video coding device from attempting to access motion information of another layer to determine a TMVP if the motion information of the other layer may not be properly attained in multilayer coding.

In one example, a method of decoding video data includes determining a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor, and restricting the temporal motion vector prediction process such that the co-located picture used to derive the temporal motion vector predictor is not located in a layer other than the first layer of the plurality of layers of video data.

In another example, a method for encoding video data includes determining a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor, and restricting the temporal motion vector prediction process such that the co-located picture used to derive the temporal motion vector predictor is not located in a layer other than the first layer of the plurality of layers of video data.

In another example, a device for coding multi-layer video data comprising a plurality of layers of video data includes a video coder configured to determine a temporal motion vector predictor for a motion vector associated with a block of video data of a current picture of a first, non-base layer of the plurality of layers of video data using a temporal motion vector prediction process, wherein the temporal motion vector prediction process includes identifying a co-located picture from which to derive the temporal motion vector predictor, and restrict the temporal motion vector prediction process such that the co-located picture used to derive the temporal motion vector predictor is not located in a layer other than the first layer of the plurality of layers of video data.

In another example, a device for coding multi-layer video data comprising a plurality of layers of video data, includes means for determining a temporal motion vector predictor for a motion vector associated with a block of video data of a current picture of a first, non-base layer of the plurality of layers of video data using a temporal motion vector prediction process, wherein the temporal motion vector prediction process includes identifying a co-located picture from which to derive the temporal motion vector predictor, and means for restricting the temporal motion vector prediction process such that the co-located picture used to derive the temporal motion vector predictor is not located in a layer other than the first layer of the plurality of layers of video data.

In another example, a computer-readable storage medium having stored thereon instructions that, when executed, cause a processor of a device for coding video data to determine a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor, and restrict the temporal motion vector prediction process such that the co-located picture used to derive the temporal motion vector predictor is not located in a layer other than the first layer of the plurality of layers of video data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for determining a temporal motion vector predictor (TMVP).

FIG. 2 is a block diagram illustrating an example of a video encoder that may implement techniques for determining a TMVP.

FIG. 3 is a block diagram illustrating an example of video decoder 30 that may implement techniques for determining a TMVP.

FIG. 4 is a conceptual diagram illustrating determining a TMVP.

FIG. 5 is a conceptual diagram illustrating an example MVC prediction pattern.

FIG. 6 is a conceptual diagram illustrating an example scalable video coding sequence.

FIG. 7 is a conceptual diagram illustrating an example clean random access (CRA) picture and example leading pictures.

FIG. 8 is a flowchart illustrating an example method for encoding a current block in accordance with the techniques of this disclosure.

FIG. 9 is a flowchart illustrating an example method for decoding a current block of video data in accordance with the techniques of this disclosure.

### DETAILED DESCRIPTION

Currently, the Motion Pictures Experts Group (MPEG) is developing a three-dimensional video (3DV) standard based on the upcoming high efficiency video coding (HEVC) standard. Part of the standardization efforts also includes the standardization of a multiview video codec and based on HEVC based on HEVC. For example, one standardization effort includes development of a multiview extension of HEVC, referred to as MV-HEVC, and another is depth enhanced HEVC-based full 3DV codec, referred to as 3D-HEVC.

The Motion Pictures Experts Group (MPEG) is also developing a scalable video codec based on HEVC, referred to as HSVC. With respect to scalable video coding, view scalability and/or spatial scalability may also contribute to three dimensional video services, as such scalabilities allow for backward-compatible extensions for more views, and/or enhancing the resolution of views in a way that allows decoding by legacy devices.

In two-dimensional video coding, video data (that is, a sequence of pictures) is coded picture by picture, not necessarily in display order. Video coding devices may divide each picture into blocks, and code each block individually. Block-based prediction modes include spatial prediction, also referred to as intra-prediction, and temporal prediction, also referred to as inter-prediction.

For three-dimensional video data, such as multiview or scalable coded data, blocks may also be inter-view and/or inter-layer predicted. As described herein, a video “layer” may generally refer to a sequence of pictures having at least one common characteristic, such as a view, a frame rate, a resolution, or the like. For example, a layer may include video data associated with a particular view (e.g., perspective) of multiview video data. As another example, a layer may include video data associated with a particular layer of scalable video data. Thus, this disclosure may interchangeably refer to a layer and a view of video data.

In some instances, blocks may be predicted from a picture of another view or layer of video data. In this manner, inter-view prediction based on reconstructed view components from different views may be enabled. This disclosure uses the term “view component” to refer to an encoded picture of a particular view or layer. That is, a view component may comprise an encoded picture for a particular view at a particular time (in terms of display order, or output order). A view component (or slices of a view component) may have a picture order count (POC) value, which generally indicates the display order (or output order) of the view component.

In temporal inter-prediction or inter-view prediction, a video coding device may code data indicative of one or more temporal motion vectors (temporal inter-prediction) and/or one or more disparity motion vectors (inter-view prediction). In some examples, a block coded with one temporal or disparity motion vector is referred to as a P-block, whereas a block coded with two motion vectors or two displacement vectors is referred to as a bi-predictive block, or B-block. Techniques that are applicable to motion vectors are also generally applicable to displacement vectors, and therefore, this disclosure primarily describes motion vector coding techniques. However, it should be understood that such techniques are also applicable to disparity motion vectors, and likewise, that techniques described with respect to disparity motion vectors are also applicable to temporal motion vectors, unless otherwise indicated.

Generally, data indicative of reference pictures, to which a motion vector or displacement vector may refer, are stored in reference picture lists. Thus, motion vector data (temporal or disparity motion vector data) may include not only data for an x-component and a y-component of the motion vector, but also an indication of an entry of the reference picture list, referred to as a reference picture index. Video coding devices may construct multiple reference picture lists. For example, a video coding device may construct a first reference picture list (list 0 or RefPicList0) to store data for reference pictures having POC values earlier than a current picture, and a second reference picture list (list 1 or RefPicList1) to store data for reference pictures having POC values later than a current picture. Again, it is noted that display or output orders for pictures are not necessarily the same as coding order values (e.g., frame number or “frame_num” values). Thus, pictures may be coded in an order that differs from the order in which the frames are displayed (or captured).

Typically, a reference picture list construction for the first or the second reference picture list of a B picture includes two steps: reference picture list initialization and reference picture list reordering (modification). The reference picture list initialization is an explicit mechanism that puts the reference pictures in the reference picture memory (also known as decoded picture buffer) into a list based on the order of POC (Picture Order Count, aligned with display order of a picture) values. The reference picture list reordering mechanism can modify the position of a picture that was put in the list during the reference picture list initialization to any new position, or put any reference picture in the reference picture memory in any position even the picture doesn't belong to the initialized list. Some pictures after the reference picture list reordering (modification) may be put in a further position in the list. However, if a position of a picture exceeds the number of active reference pictures of the list, the picture is not considered as an entry of the final reference picture list. The number of active reference pictures of maybe signaled in a slice header for each list. After reference picture lists are constructed (e.g., RefPicList0 and RefPicList1, if available), a reference index can be used to identify a picture in any reference picture list.

As noted above, motion vector data may also include a horizontal component (or x-component) and a vertical component (or y-component). Thus, a motion vector may be defined as <x, y>. Rather than coding the x-component and y-component of a motion vector directly, video coding devices may code the delta values of motion vectors relative to so-called “motion vector predictors.” Thus, a motion vector is defined by the motion vector predictor plus the delta values, which indicate a difference between the motion vector predictor and the motion vector being coded. Motion vector predictors may be selected from spatial neighbors for a current block, a collocated block of a temporally separate picture (e.g., a collocated block in a previously coded picture), or a corresponding block of a picture in another view at the same temporal instance, in various examples. Motion vector predictors of a temporally separate picture are referred to as temporal motion vector predictors (TMVPs).

To determine a TMVP for a current block (e.g., a current prediction unit (PU) of a current coding unit (CU) in HEVC), a video coding device may first identify a co-located picture. The term “co-located picture” refers to a picture including a particular co-located block. The co-located block may also be included in a “co-located partition,” as indicated in WD8 of HEVC. If the current picture is a B slice, a collocated_from 10 flag may be signaled in a slice header of a slice of the current picture to indicate whether the co-located picture is from RefPicList0 or RefPicList1.

After a reference picture list is identified, the video coding device may use collocated_ref_idx, signaled in the slice header, to identify the co-located picture in the reference picture list. A co-located PU is then identified by checking the co-located picture. Either the motion vector of the right-bottom PU of the CU containing the current PU, or the motion vector of the right-bottom PU within the center PUs of the CU containing this PU, may be treated as the TMVP for the current PU. When motion vectors identified by the above process are used to generate a motion candidate for AMVP or merge mode, they may be scaled based on the temporal location (reflected by POC value of the reference picture).

In HEVC, the picture parameter set (PPS) includes a flag enable_temporal_mvp_flag. When a particular picture with temporal_id equal to 0 refers to a PPS having enable_temporal_mvp_flag equal to 0, all the reference pictures in the DPB may be marked as “unused for temporal motion vector prediction,” and no motion vector from pictures before that particular picture in decoding order would be used as a TMVP in decoding of the particular picture or a picture after the particular picture in decoding order.

When deriving a TMVP for a uni-directional inter-predicted block, the reference picture list corresponding to the direction of the motion vector for the block being coded is used for TMVP derivation. That is, if the motion vector for the current block points to a reference picture in list 0, the TMVP may be derived using a co-located block in list 0. If the motion vector for the current block points to a reference picture in list 1, the TMVP may be derived using a co-located block in list 1.

U.S. patent application Ser. No. 13/801,350 filed Mar. 13, 2013 and assigned to Qualcomm Incorporated and incorporated herein by reference, proposes that a disparity motion vector should not be used to predict a temporal motion vector and a temporal motion vector should not be used to predict a disparity motion vector. Thus, for multiview video coding, collocated_ref_idx is set in a way that the co-located picture does not correspond to a reference picture in a different view.

However, the techniques described by U.S. patent application Ser. No. 13/801,350 did not address aspects of multilayer scalable video coding addressed by this disclosure. For example, with scalable video coding, a video coding device may include a base layer representation, possibly after upsampling and/or filtering, in a reference picture list of a current picture of a current layer. Such a picture may be referred to as an inter-layer reference picture.

Multilayer callable video coding may be achieved, in some instances, with a high level syntax (HLS)-only scalable video coding extension (such as and SVC extension to HEVC, referred to as HSVC). For example, multiview video coding, three-dimensional video coding (multiview plus depth), or scalable video coding extensions (such as extensions of H.264/AVC or HEVC) may be achieved using HLS changes to the base standard. In such extensions, rather than introducing new coding structures, certain existing coding structures may be redefined or used in a different way to achieve an HLS-only extension.

Accordingly, a “HLS-only” enhancement layer is an enhancement layer that is coded using only HLS changes, such that block level coding need not be redesigned and can be reused. That is, modifications of syntax elements under a slice header are typically not allowed for HLS-only enhancement layers. In addition, with respect to HEVC, for example, coding unit (CU)-level decoding process changes are typically not allowed for HLS-only enhancement layers. As an example, motion vector prediction of an HEVC extension specification should be the same as that in the HEVC base specification when coding using an HLS-only enhancement layer.

An HLS-only extension may allow a base layer picture to be added to a reference picture list for coding a picture in a layer other than the base layer (referred to above as an inter-layer reference picture). Although adding a picture from one layer to a reference picture list for coding another layer may be permitted, with respect to scalable HEVC (HSVC) or a multi-standard codec, determining a TMVP using such a layer may not always be possible.

For example, in scalable video coding, a base layer may have a different, lower resolution that an enhancement layer. In this example, a video coding device may typically upsample the base layer prior to using the base layer as a reference for coding the enhancement layer. However, in order for the video coder to upsample and use the base layer, the video coder must use block-level tools to interpolate the motion field (e.g., motion vector information including offset and reference picture information) for the base layer. In an HLS-only SVC extension of HEVC, such block-level tools for determining the motion field are not available.

As described with respect to the example above, a video coding device may not be able to properly determine a TMVP associated with a co-located picture in a base layer for predicting a motion vector of a block in an HSVC enhancement layer when the base layer has a different resolution than the enhancement layer. That is, it is not possible to determine the TMVP associated with the co-located picture in the base layer, because the motion field of the base layer, which is required for determining the TMVP, is not available. Accordingly, if the video coding device attempts to determine a TMVP from a base layer in such circumstances, the video coding device may reach an unexpected result and fail to operate properly.

While the example above is described with respect to a scalable video coding scheme in which a base layer and an enhancement layer have different resolutions, a similar issue may arise with multi-standard coding, e.g., an H.264/AVC base layer and an HEVC enhancement layer. For example, assume that a base layer is coded using the H.264/AVC video coding standard and an enhancement layer is coded using HEVC. In this example, a video coding device cannot properly determine a TMVP for the enhancement layer if the co-located picture is located in the AVC coded base layer, because the motion field for the base layer (which is required for determining the TMVP) may not be understood and/or relatable to the enhancement layer.

Techniques of this disclosure include controlling a temporal motion vector prediction process in multilayer video coding. For example, aspects of this disclosure include restricting a temporal motion vector prediction process, such that a TMVP from one layer is not used to predict a motion vector of a block in another, different layer. In some instances, the techniques may be implemented to support an HLS-only HEVC codec or a multi-standard codec that codes an enhancement layer that conforms to HEVC. The techniques may be used to avoid encountering a situation in which a TMVP may not be properly attained in scalable, multilayer coding (e.g., when a motion field for one layer is not available for coding another layer, as described above with respect to the HSVC enhancement layer and multi-standard examples).

According to aspects of this disclosure, a video coder may restrict a temporal motion vector prediction process by imposing one or more constraints on the temporal motion vector prediction process. For example, when temporal motion vector prediction is enabled in the sequence level (e.g., sps temporal mvp_enable_flag is equal to 1), the video coder may be restricted from selecting a co-located picture for a TMVP that does not belong to the same layer as the picture currently being coded. In this example, the video coder is not necessarily prevented from determining a TMVP, and may be forced to select a reference picture in the same layer as the picture currently being coded as a reference picture for determining a TMVP.

While the techniques described above generally relate to restricting a temporal motion vector prediction process, according to aspects of this disclosure, in some examples, the temporal motion vector prediction process may be disabled altogether. For example, according to some aspects of this disclosure, temporal motion vector prediction may be disabled for slices of a picture currently being coded that do not include any reference pictures in a reference picture list that are in the same layer as the picture currently being coded. In this way, temporal motion vector prediction can be enabled or disabled on a slice-by-slice basis, e.g., for each slice of a picture that does not include any reference pictures in a reference picture list in the same layer as the layer being coded.

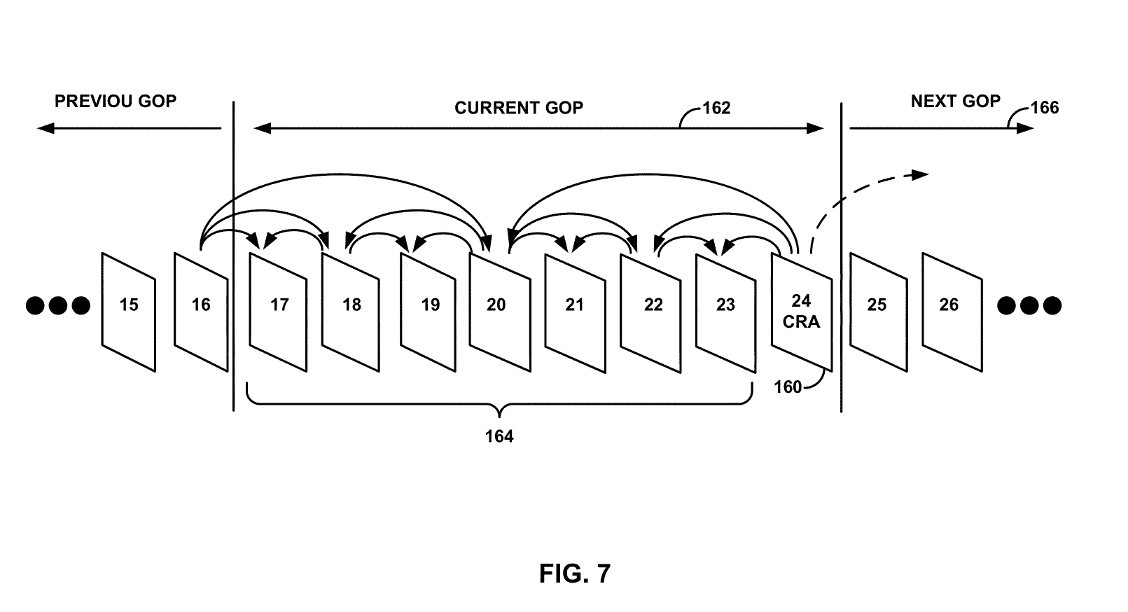

As another example, according to aspects of this disclosure, a video coder may enable or disable the temporal motion vector prediction process based on whether the picture currently being coded is a random access picture. In general, a random access picture allows the video coding device to begin to properly decode a video sequence and is typically intra-coded (as described in greater detail, for example, with respect to FIG. 7 below). The concept of random access in HEVC is extended to multiview and 3DV extensions of HEVC (such as the scalable extension of HEVC (HSVC)). For example, for a particular picture in a multiview or scalable sequence (e.g., a view component), if the view component is one of the random access picture types defined in the HEVC base specification, the view component is a random access point view component (also referred to as a random access point picture of the current view).

In multiview or scalable video coding, the prediction constraints typically associated with random access pictures (e.g., disabling or otherwise constraining temporal prediction) are generally only applied in the temporal dimension (e.g., inside a view or layer). Thus, inter-layer prediction for a random access point view component is still possible, which may improve coding efficiency, similar to an anchor picture in H.264/MVC. Accordingly, in multiview or scalable video coding, a random access point (RAP) view component using inter-view prediction may be a P- or B-picture.

Inter-layer reference pictures may be included in a reference picture list, and may therefore be a potential candidate for determining a TMVP. However, in general, a temporal motion field, and therefore temporal prediction (on which a TMVP relies), is not available for random access pictures. Accordingly, an issue may arise similar to that described above, in which a co-located reference picture located in a different layer may be included in a reference picture list for determining a TMVP, but a video coder cannot properly determine a TMVP from the co-located picture.

According to aspects of this disclosure, a temporal motion vector prediction process may be enabled or disabled based on when the current picture is a random access picture. Such a technique may be used to avoid encountering a situation in which a TMVP may not be properly attained for a random access picture, as noted above.

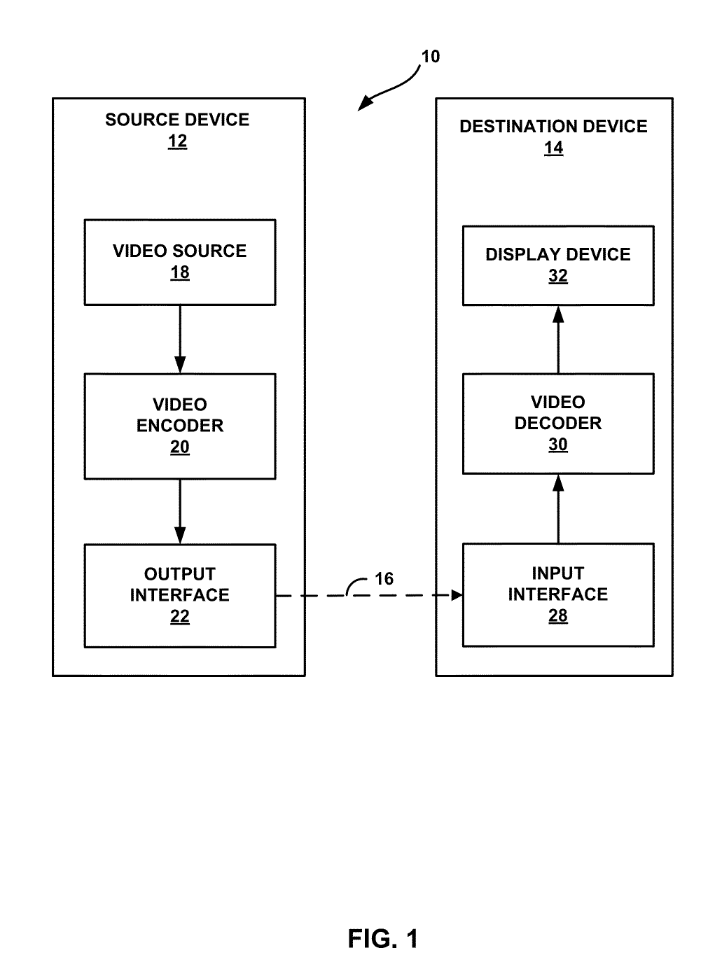

FIG. 1 is a block diagram illustrating an example video encoding and decoding system 10 that may utilize techniques for determining a TMVP. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for determining a TMVP. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for determining a TMVP may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage device 24) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Video encoder 20 and video decoder 30 may operate according to a video compression standard, such as the ITU-T H.264 standard, alternatively referred to as MPEG-4, Part 10, Advanced Video Coding (AVC), or extensions of such standards. The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. Other examples of video compression standards include MPEG-2 and ITU-T H.263.

While the techniques of this disclosure are not limited to any particular coding standard, the techniques may be relevant to the HEVC standard. More specifically, video encoder 20 and video decoder 30 may be configured to code video data according to an extension of the HEVC standard, e.g., a multiview extension or three-dimensional video (3DV) extension, including a scalable video coding (SVC) extension.

In general, HEVC allows a video picture to be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive coding tree units (CTUs). Each of the CTUs may comprise a coding tree block of luma samples, two corresponding coding tree blocks of chroma samples, and syntax structures used to code the samples of the coding tree blocks. In a monochrome picture or a picture that have three separate color planes, a CTU may comprise a single coding tree block and syntax structures used to code the samples of the coding tree block.

A video picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that have three separate color planes, a CU may comprise a single coding block and syntax structures used to code the samples of the coding block. A coding block is an N×N block of samples.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. A prediction block may be a rectangular (i.e., square or non-square) block of samples on which the same prediction is applied. A PU of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples.

TUs may include coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that have three separate color planes, a TU may comprise a single transform block and syntax structures used to transform the transform block samples.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, picture-based syntax data, and group of pictures (GOP)-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

Video encoder 20 and video decoder 30 may be configured to perform one or more of the various techniques of this disclosure, alone or in any combination. For example, in accordance with certain techniques of this disclosure, video encoder 20 and video decoder 30 may be configured to perform various techniques related to scalable video coding, e.g., as extensions of H.264/AVC or HEVC. As noted above, scalable extensions of video coding standards can be achieved, in some instances, using high level syntax (HLS) changes to the base standard. For example, rather than introducing new coding structures, certain existing coding structures may be redefined or used in a different way to achieve an HLS-only extension.

As an example, to code video data in accordance with MVC, 3DV, and/or SVC extensions, video encoder 20 and video decoder 30 may be configured to perform inter-layer or inter-view prediction. That is, video encoder 20 and video decoder 30 may be configured to predict blocks of a current picture in a current view using data of a previously coded picture of a previously coded view. Typically, the previously coded picture (i.e., the inter-view reference picture) and the current picture have the same picture order count (POC) value, such that the inter-view reference picture and the current picture occur in the same access unit, and likewise, have substantially the same output order (or display order).

Video encoder 20 and video decoder 30 may be configured to perform various modes of motion vector prediction. In one example, merge mode, video encoder 20 and video decoder 30 may be configured to code a merge flag representative of from which of a plurality of neighboring blocks to inherit motion parameters, such as, for example, a reference picture list from which to select a reference picture, a reference index indicative of the reference picture in the reference list, a horizontal motion vector component, and a vertical motion vector component.

In another example, advanced motion vector prediction (AMVP), video encoder 20 and video decoder 30 may be configured to code an indication of a reference picture list from which to select a reference picture, a reference index indicative of a reference picture in the reference picture list, a motion vector difference value, and an AMVP index representative of a neighboring block from which to select a motion vector predictor.

In merge mode and/or AMVP mode, or other such motion vector coding modes, video encoder 20 and video decoder 30 may be configured not to use motion information from a neighboring block that uses a motion vector of a different type than a motion vector of a current block. That is, video encoder 20 and video decoder 30 may be configured to determine a first type for a current motion vector, a second type for a candidate motion vector predictor, and if the first type is not the same as the second type, to disable the use of the candidate motion vector predictor as a motion vector predictor for the current motion vector.

To disable the candidate motion vector predictor, video encoder 20 and video decoder 30 may set a variable representative of whether the candidate motion vector predictor is available for use as a motion vector predictor for the current motion vector. Video encoder 20 and video decoder 30 may set a value for this variable to indicate that the candidate motion vector predictor is not available, even when the candidate motion vector predictor had previously been considered available based on other conditions that indicated that the candidate motion vector predictor was available. For example, as explained in greater detail below, video encoder 20 and video decoder 30 may associate a variable with the candidate motion vector predictor, where the value of the variable indicates whether the candidate motion vector predictor is available for use as a motion vector predictor for the current motion vector.

In particular, video encoder 20 may be configured to determine a set of motion vector predictors that are available for use to predict the current motion vector. Video decoder 30 may also be configured to construct such a set, or alternatively, video encoder 20 may signal the set of motion vector predictors that are available. In any case, video encoder 20 and video decoder 30 may determine a set of available motion vector predictors, and select one of the set of motion vector predictors as the actual motion vector predictor to use to code the current motion vector.

In AMVP mode, video encoder 20 may calculate motion vector difference values between the current motion vector and the motion vector predictor and code the motion vector difference values. Likewise, video decoder 30 may combine the motion vector difference values with the determined motion vector predictor to reconstruct the current motion vector (i.e., a motion vector for a current block of video data, e.g., a current PU). In merge mode, the actual motion vector predictor may be used as the current motion vector. Thus, in merge mode, video encoder 20 and video decoder 30 may treat the motion vector difference values as being zero-valued.

Video encoder 20 and video decoder 30 may, in some instances, determine one or more motion vector predictors from a collocated block of a temporally separate picture (that is, a collocated block in a previously coded picture), which are referred to as temporal motion vector predictors (TMVPs). To determine a TMVP for a current block (e.g., a current prediction unit (PU) of a current coding unit (CU) in HEVC), video encoder 20 and video decoder 30 may first identify a so-called co-located picture. If the current picture is a B slice, video encoder 20 may signal a collocated_from 10 flag in a slice header of a slice of the current picture to indicate whether the co-located picture is from RefPicList0 or RefPicList1, which may be decoded by video decoder 30. After a reference picture list is identified, video decoder 30 may use a collocated_ref_idx syntax element, signaled in the slice header, to identify the co-located picture in the reference picture list. Video decoder 30 may then identify a co-located PU by checking the co-located picture. Either the motion vector of the right-bottom PU of the CU containing the current PU, or the motion vector of the right-bottom PU within the center PUs of the CU containing this PU, may be treated as the TMVP for the current PU.

In scalable video coding with multiple coded layers, when coding a picture in a first layer, video encoder 20 and/or video decoder 30 may include picture from another layer in a reference picture list for coding the picture in the first layer. For example, video encoder 20 and/or video decoder 30 may upsample and/or filter a picture of a base layer and include the base layer picture in a reference picture list for coding a picture of an enhancement layer. As noted above, such a picture may be referred to as an inter-layer reference picture.

Including a picture in a reference picture list typically makes that picture available for selection as a co-located picture, e.g., when determining a TMVP. However, as noted above, in some instances, the motion field of one layer is not available when coding another, different layer (e.g., when a base layer and an enhancement layer have different resolutions, when a base layer and an enhancement layer are coded with different video coding standards, when the picture being coded is a random access picture, or the like). In such instances, video encoder 20 and/or video decoder 30 may not be able to properly determine a TMVP associated with a co-located picture of a different layer.

Aspects of this disclosure include controlling a temporal motion vector prediction process in multilayer video coding, including restricting the temporal motion vector prediction process when a TMVP may not be attainable, e.g., due to an unavailable motion field. As noted above, in some instances, the techniques may be implemented to support an HLS-only HEVC codec or a multi-standard codec that codes an enhancement layer that conforms to HEVC.

For example, according to aspects of this disclosure, video encoder 20 and/or video decoder 30 may determine a TMVP for a motion vector associated with a block of video data of a current picture of a first layer using a temporal motion vector prediction process, where the temporal motion vector prediction process includes identifying a co-located picture from which to derive the TMVP. In addition, video encoder 20 and/or video decoder 30 may restrict the temporal motion vector prediction process such that the co-located picture used to derive the TMVP is not located in a layer other than the first layer.

In this way, video encoder 20 and/or video decoder 30 may be restricted from selecting a co-located picture for a TMVP that does not belong to the same layer as the picture currently being coded. In this example, video encoder 20 and/or video decoder 30 may not be prevented from determining a TMVP, but may be forced to select a reference picture in the same layer as the picture currently being coded as a co-located picture for determining a TMVP.

According to aspects of this disclosure, video encoder 20 and/or video decoder 30 may impose the temporal motion vector prediction process constraint described above when performing HLS-only HSVC coding. That is, video encoder 20 may be configured to automatically impose the restriction on the temporal motion vector prediction process (e.g., that the co-located picture for determining a TMVP is included in the same layer as the picture currently being coded) whenever video encoder 20 is encoding a bitstream that conforms to HLS-only HSVC. Likewise, video decoder 30 may be configured to automatically impose the restriction on the temporal motion vector prediction process upon determining that a bitstream currently being decoded conforms to HLS-only HSVC.

In another example, video encoder 20 may impose the temporal motion vector prediction process constraint by indicating the restriction using one or more syntax elements in an encoded bitstream. In this example, video encoder 20 may set a collocated_ref_idx syntax element such that the co-located picture does not become a reference picture that is not included in the same layer as the current picture. That is, video encoder 20 may set a RefPicListX[collocated_ref_idx] syntax element such that collocated_ref_idx belongs to the same layer of the current picture, with X being equal to collocated_from_{—10}_flag. Video decoder 30 may obtain such syntax elements from an encoded bitstream and impose the restriction in a reciprocal manner.

While the techniques described above generally relate to restricting a temporal motion vector prediction process, according to aspects of this disclosure, in some examples, prior to determining the TMVP, the temporal motion vector prediction process may be disabled altogether. For example, according to some aspects of this disclosure, video encoder 20 and/or video decoder 30 may disable temporal motion vector prediction for slices of a picture currently being coded that do not include any reference pictures in a reference picture list that are in the same layer as the slice.

As one example, prior to determining a TMVP, video encoder 20 and/or video decoder 30 may determine whether the slice currently being coded includes at least one reference picture of the same layer in reference picture list X, (with X being equal to collocated_from_{—10}_flag). If the slice does not include any reference picture in the same layer, video encoder 20 and/or video decoder 30 may disable the temporal motion vector prediction process such that a TMVP is not determined. In this way, video encoder 20 and/or video decoder 30 may enable or disable the temporal motion vector prediction process on a slice-by-slice basis.

Video encoder 20 and/or video decoder 30 may enable or disable the temporal motion vector prediction process using a constraint that is automatically imposed at both video encoder 20 and/or video decoder 30, or by using one or more syntax elements to indicate whether the temporal motion vector prediction process is enabled or disabled, as noted above. That is, in one example, video encoder 20 and/or video decoder 30 both automatically disable the temporal motion vector prediction process based on whether the picture currently being coded has a reference picture in the reference picture list in the same layer as the picture being coded.

In another example, video encoder 20 may disable the temporal motion vector prediction process by indicating the constraint using one or more syntax elements. In this example, video encoder 20 may set a slice_temporal_mvp_enable_flag syntax element equal to zero, thereby disabling the temporal motion vector prediction process for the slice. Video decoder 30 may obtain this syntax element from an encoded bitstream and impose the constraint in a reciprocal manner.

As another example, according to aspects of this disclosure, video encoder 20 and/or video decoder 30 may enable or disable the temporal motion vector prediction process based on whether the picture currently being coded is a random access picture (as described in greater detail, for example, with respect to FIG. 7 below). In this example, video encoder 20 and/or video decoder 30 may enable or disable the temporal motion vector prediction process on a slice-by-slice basis or a picture-by-picture basis.

For example, video encoder 20 and/or video decoder 30 may automatically disable the temporal motion vector prediction process when the picture being coded is a random access picture. In another example, video encoder 20 and/or video decoder 30 may disable the temporal motion vector prediction process by indicating the constraint using one or more syntax elements. That is, as noted above, video encoder 20 may set a slice_temporal_mvp_enable_flag syntax element equal to zero, thereby disabling the temporal motion vector prediction process for each slice of a random access picture. Video decoder 30 may obtain this syntax element from an encoded bitstream and impose the constraint in a reciprocal manner.

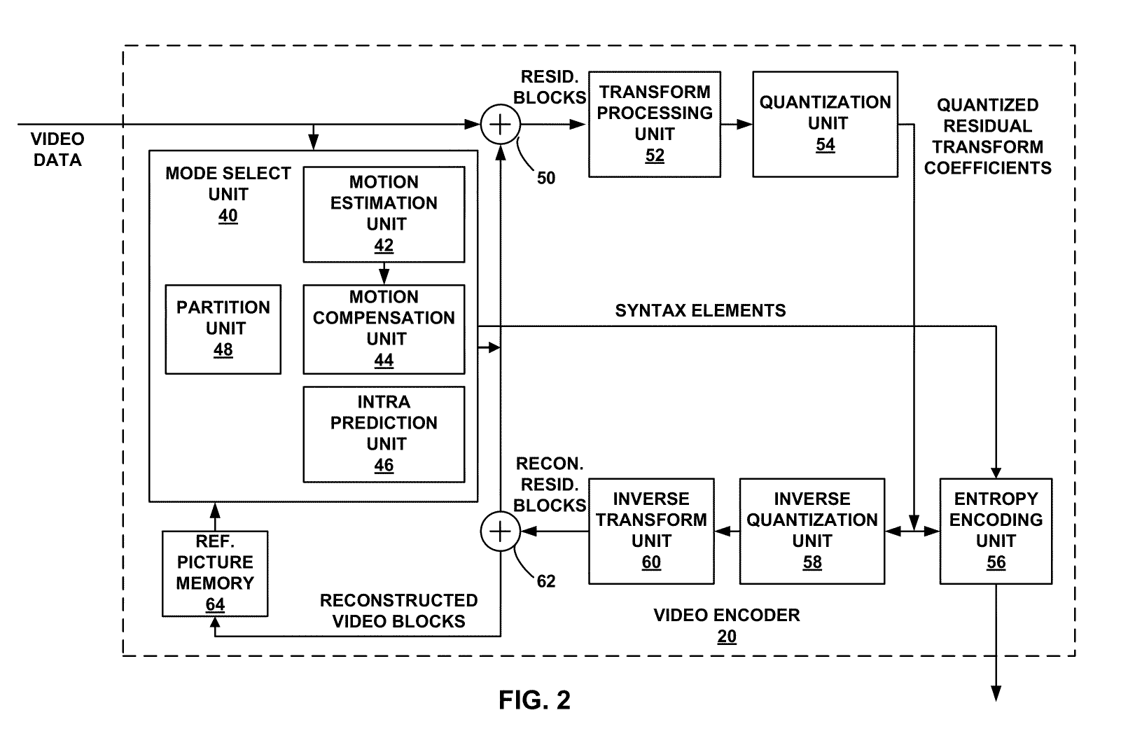

FIG. 2 is a block diagram illustrating an example of video encoder 20 that may implement techniques for determining a TMVP. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As noted above, video encoder 20 may be adapted to perform multiview and/or scalable video coding. For example, video encoder 20 may be configured to encode multiple, scalable layers of video data in accordance with an HSVC video coding standard. In some instances, video encoder 20 may code different scalable layers of video data using different video coding standards. Thus, while reference is made to specific coding standards, it should be understood that the techniques are not specific to any one coding standard, and may be implemented with future and/or not yet developed standards.

In any case, as shown in FIG. 2, video encoder 20 receives a current video block within a video frame to be encoded. In the example of FIG. 2, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

When mode select unit 40 elects to inter-predict a block of video data (e.g., a PU) using motion estimation unit 42 and motion compensation unit 44, video encoder 20 may further encode the motion vector, e.g., using AMVP or merge mode. When video encoder 20 signals the motion information of a current PU using merge mode, video encoder 20 may generate a merging candidate list that includes one or more merging candidates. Each of the merging candidates specifies the motion information of a spatial motion vector predictor or a TMVP.

A spatial motion vector predictor may be a PU in the current picture (i.e., the picture that includes the current PU). A TMVP may be a PU in a temporal reference picture (i.e., a picture that occurs at a different time instance than the current picture). In multilayer video coding, the temporal reference picture may alternatively be included in a picture in a different layer, e.g., an inter-layer reference picture. After generating the merging candidate list, video encoder 20 may select one of the merging candidates. Entropy encoding unit 56 may entropy encode one or more syntax elements that indicates the position, within the merging candidate list, of the selected merging candidate.

Video encoder 20 may perform a similar process, e.g., constructing a candidate list and selecting a candidate from the list, to carry out AMVP. For example, entropy encoding unit 56 may receive a motion vector from mode select unit 40 and encode the motion vector. Entropy encoding unit 56 may entropy encode a motion vector using AMVP by selecting a motion vector predictor included in a motion vector predictor candidate list and calculating a difference between the motion vector and the motion vector predictor (e.g., a horizontal motion vector difference and a vertical motion vector difference), then entropy encode one or more syntax elements representative of the difference(s).

In general, a motion vector may be defined by a horizontal component (or x-component) and a vertical component (or y-component). Accordingly, entropy encoding unit 56 may calculate MVDx (an x-component of a motion vector difference) as the difference between the x-component of the motion vector being encoded and the x-component of the motion vector predictor. Likewise, entropy encoding unit 56 may calculate MVDy (a y-component of the motion vector difference) as the difference between the y-component of the motion vector being encoded and the y-component of the motion vector predictor. In the case that the motion vector is a temporal motion vector, entropy encoding unit 56 may calculate the motion vector difference values (MVDx and MVDy) relative to a scaled version of the motion vector predictor (based on POC differences between reference pictures referred to by the motion vector being encoded and motion vector predictor). Entropy encoding unit 56 may then entropy encode MVDx and MVDy, e.g., using CABAC.

As indicated above, a merging candidate list or an AMVP candidate list may include candidates that specify the motion information of PUs that temporally neighbor a current PU or that are included in a different layer than the current PU (in the case of multilayer video coding). This disclosure may use the term “temporal motion vector predictor” or “TMVP” to refer to a PU that is a temporal or inter-layer neighbor of a current PU and whose motion information is specified by a temporal merging candidate or a temporal MVP candidate.

Video encoder 20 may use a temporal motion vector prediction process to determine a TMVP. For example, video encoder 20 may first identify a reference picture that includes a PU that is co-located with the current PU. In other words, video encoder 20 may identify a co-located picture. If the current slice of the current picture is a B slice (i.e., a slice that is allowed to include bi-directionally inter predicted PUs), video encoder 20 may signal, in a slice header, a syntax element (e.g., collocated_from_{—}10_flag) that indicates whether the co-located picture is from RefPicList0 or RefPicList1. In other words, if the current slice (i.e., the slice containing the current PU) is in a B slice and a collocated_from_{—}10_flag syntax element in a slice header of the current slice indicates that the co-located reference picture is in RefPicList1, the co-located reference picture may be the reference picture in RefPicList1 at a location indicated by a collocated_ref_idx syntax element of the slice header. Otherwise, if the current slice is a P slice or the current slice is a B slice and the collocated_from_{—}10_flag syntax element in the slice header of the current slice indicates that the co-located reference picture is in RefPicList0, the co-located reference picture may be the reference picture in RefPicList0 at a location indicated by the collocated_ref_idx syntax element of the slice header. After video encoder 20 identifies the reference picture list, video encoder 20 may use another syntax element (e.g., collocated_ref_idx), which may be signaled in a slice header, to identify a picture (i.e., the co-located picture) in the identified reference picture list.

Video encoder 20 may identify a co-located PU by checking the co-located picture. In some examples, video encoder 20 may use either the motion of the right-bottom PU of the CU containing this PU, or the motion of the right-bottom PU within the center PUs of the CU containing the co-located PU. The right-bottom PU of the CU containing the co-located PU may be a PU that covers a location immediately below and right of a bottom-right sample of a prediction block of the PU. In other words, the TMVP may be a PU that is in the co-located picture and that covers a location that is co-located with a bottom right corner of the current PU, or the TMVP may be a PU that is in the co-located picture and that covers a location that is co-located with a center of the current PU. Thus, the co-located PU may be a PU that covers a center block of a co-located region of the co-located picture or a PU that covers a bottom-right block of the co-located region of the co-located picture, the co-located region being co-located with the current PU.

Video encoder 20 may include a TMVP determined using the temporal motion vector prediction process described above as a merging candidate for merge mode or as an MVP candidate for AMVP mode. It should be understood that the “temporal motion vector prediction process” described above is provided for purposes of example only, and other processes for determining a TMVP may include more, fewer, or alternative steps than the example described above. Accordingly, a temporal motion vector prediction process generally includes any steps for determining a TMVP, including, for example, locating a co-located picture and determining a TMVP from the co-located picture.

According to aspects of this disclosure, video encoder 20 may restrict a temporal motion vector prediction process for determining a TMVP (such as the process for determining a TMVP described above) from determining a TMVP in a layer other than a layer currently being encoded. For example, according to aspects of this disclosure, entropy encoding unit 56 may determine a TMVP for a current PU in a first layer using a temporal motion vector prediction process, including identifying a co-located picture from which to derive the TMVP. In addition, video encoder 20 may restrict the temporal motion vector prediction process such that the co-located picture used to derive the TMVP is not located in a layer other than the first layer.

In this way, entropy encoding unit 56 may be restricted from selecting a co-located picture for a TMVP that does not belong to the same layer as the picture currently being coded. In this example, entropy encoding unit 56 may not be prevented from determining a TMVP and including the TMVP in a candidate list. However, entropy encoding unit 56 may only identify a reference picture in a reference picture list as a co-located reference picture that is included in the same layer as the picture currently being coded.

According to aspects of this disclosure, video encoder 20 may automatically impose the temporal motion vector prediction process constraint described above whenever video encoder 20 performs coding to produce a bitstream conforming to a particular standard or more than one standard. For example, video encoder 20 may impose the temporal motion vector prediction process constraint when coding a bitstream that conforms to HLS-only HSVC coding. In another example, video encoder 20 may impose the temporal motion vector prediction process constraint when coding a bitstream that conforms to multiple standards, such as an H.264/AVC base layer and an HEVC enhancement layer.

Entropy encoding unit 56 may set a collocated_ref_idx syntax element such that the co-located picture does not become a reference picture that is not included in the same layer as the current picture. That is, entropy encoding unit 56 may set a RefPicListX[collocated_ref_idx] syntax element such that collocated_ref_idx belongs to the same layer of the current picture, with X being equal to collocated_from_{—}10_flag.

In some examples, prior to determining a TMVP, video encoder 20 may determine whether to enable the temporal motion vector prediction process based on one or more conditions. If the temporal motion vector prediction process is not enabled, video encoder 20 may not include a TMVP in a merge mode or AMVP candidate list, and a TMVP will not be used to code a motion vector for a block currently being coded.

In one example, video encoder 20 may disable the temporal motion vector prediction process from being performed based on the reference pictures identified in a slice header of the slice currently being encoded. For example, video encoder 20 may disable temporal motion vector prediction for slices being encoded that do not include any reference pictures in a reference picture list that belong to the same layer as the slices being coded. Video encoder 20 may automatically impose this constraint (with video decoder 30 imposing a similar constraint and not determining a TMVP), or may indicate the constraint using one or more syntax elements in an encoded bitstream. For example, entropy encoding unit 56 may set a slice_temporal_mvp_enable_flag syntax element equal to zero to disabling the temporal motion vector prediction process for a slice.

In another example, according to aspects of this disclosure, video encoder 20 may disable the temporal motion vector prediction process from being performed based on the type of picture being encoded. For example, video encoder 20 may disable the temporal motion vector prediction process when the picture currently being coded is a random access picture (as described in greater detail, for example, with respect to FIG. 7 below). Again, video encoder 20 may automatically impose this constraint (with video decoder 30 imposing a similar constraint and not determining a TMVP), or may indicate the constraint using one or more syntax elements in an encoded bitstream, such as by setting slice_temporal_mvp_enable_flag syntax element equal to zero.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

In this manner, video encoder 20 of FIG. 2 represents an example of a video encoder configured to determine a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor, and restrict the temporal motion vector prediction process such that the co-located picture used to derive the temporal motion vector predictor is not located in a layer other than the first layer of the plurality of layers of video data.

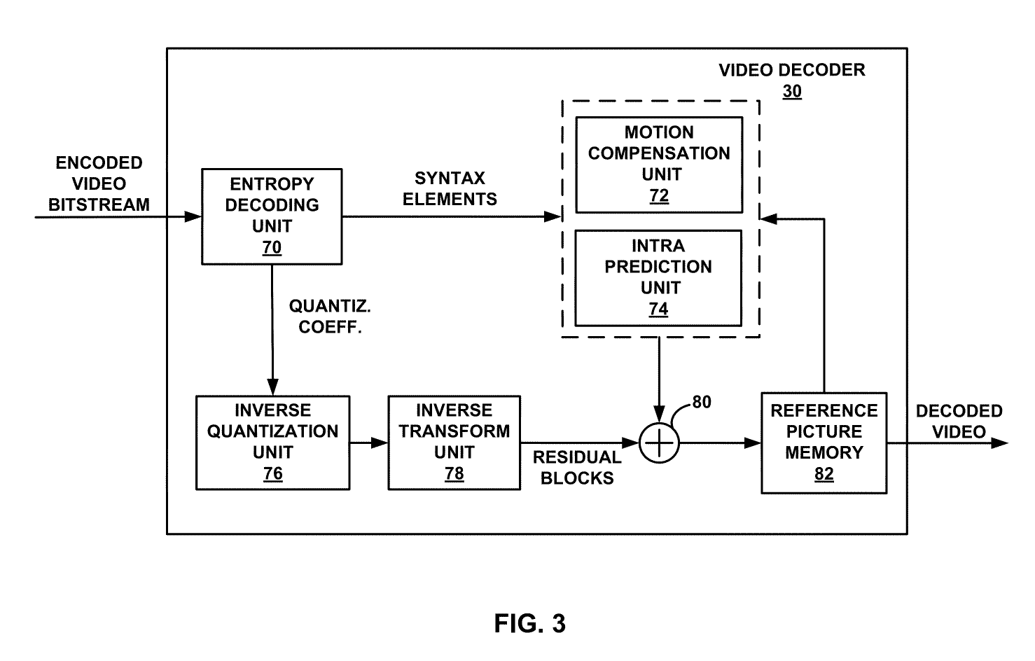

FIG. 3 is a block diagram illustrating an example of video decoder 30 that may implement techniques for determining a TMVP using a temporal motion vector prediction process. As noted above, video decoder 30 may be adapted to perform multiview and/or scalable video coding. For example, video decoder 30 may be configured to decode multiple, scalable layers of video data in accordance with an HSVC video coding standard. In some instances, video decoder 30 may decode different scalable layers of video data using different video coding standards. Thus, while reference is made to specific coding standards, it should be understood that the techniques are not specific to any one coding standard, and may be implemented with future and/or not yet developed standards.

In the example of FIG. 3, video decoder 30 includes an entropy decoding unit 70, motion compensation unit 72, intra prediction unit 74, inverse quantization unit 76, inverse transformation unit 78, reference picture memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Entropy decoding unit 70 may entropy decode motion vectors for P- and B-coded blocks. In some examples, entropy decoding unit 70 may decode motion vectors using AMVP or merge mode, and may determine one or more motion vector predictors (including one or more TMVPs). For example, to decode a current motion vector, entropy decoding unit 70 may select one of a plurality of candidate motion vector predictors (e.g., as indicated by syntax data, or according to an implicit selection process). Video decoder 30 may generate an AMVP or merge mode motion vector predictor candidate list in the same manner as that described above with respect to video encoder 20. In addition, entropy decoding unit 70 may decode a syntax element from an encoded bitstream indicating an index to the list and use may the syntax element to determine the selected motion vector predictor candidate in the candidate list. Entropy decoding unit 70 may then use the motion information indicated by the selected motion vector predictor candidate to determine the motion information of the current PU.

With respect to AMVP, entropy decoding unit 70 may also decode syntax elements representing an MVDx value (that is, a horizontal or x-component of a motion vector difference) and an MVDy value (that is, a vertical or y-component of the motion vector difference). Entropy decoding unit 70 may also add the MVDx value to an x-component of the selected (and potentially scaled) motion vector predictor to reproduce the x-component of the current motion vector, and add the MVDy value to a y-component of the selected (and potentially scaled) motion vector predictor to reproduce the y-component of the current motion vector. Entropy decoding unit 70 may provide the reproduced (i.e., decoded) motion vector to motion compensation unit 72.

In some examples, video decoder 30 and entropy decoding unit 70 may use a temporal motion vector prediction process similar to that described above with respect to FIG. 2 to determine a TMVP. For example, video decoder 30 may first identify a reference picture that includes a PU that is co-located with the current PU. In some examples, video decoder 30 may determine the co-located picture based on a collocated_ref_idx syntax element included in the encoded bitstream, as well as a collocated_from 10 flag in the case of a B-picture that indicates whether the co-located picture is from RefPicList0 or RefPicList1. Video decoder 30 may then identify a co-located PU by checking the co-located picture. In some examples, video decoder 30 may use either the motion of the right-bottom PU of the CU containing this PU, or the motion of the right-bottom PU within the center PUs of the CU containing the co-located PU.

Video decoder 30 may include a TMVP determined using the temporal motion vector prediction process described above as a merging candidate for merge mode or as an MVP candidate for AMVP mode. It should be understood that the “temporal motion vector prediction process” described above is provided for purposes of example only, and other processes for determining a TMVP may include more, fewer, or alternative steps than the example described above. Accordingly, a temporal motion vector prediction process generally includes any steps for determining a TMVP, including, for example, locating a co-located picture and determining a TMVP from the co-located picture.

According to aspects of this disclosure, video decoder 30 may restrict a temporal motion vector prediction process for determining a TMVP (such as the process for determining a TMVP described above) from determining a TMVP in a layer other than a layer currently being decoded. For example, according to aspects of this disclosure, entropy decoding unit 70 may determine a TMVP for a current PU in a first layer using a temporal motion vector prediction process, including identifying a co-located picture from which to derive the TMVP. In addition, video decoder 30 may restrict the temporal motion vector prediction process such that the co-located picture used to derive the TMVP is not located in a layer other than the first layer.

In this way, entropy decoding unit 70 may be restricted from selecting a co-located picture for a TMVP that does not belong to the same layer as the picture currently being coded. In this example, entropy decoding unit 70 may not be prevented from determining a TMVP and including the TMVP in a candidate list. However, entropy decoding unit 70 may only identify a reference picture in a reference picture list as a co-located reference picture that is included in the same layer as the picture currently being coded.

According to aspects of this disclosure, video decoder 30 may automatically impose the temporal motion vector prediction process constraint described above whenever entropy decoding unit 70 decodes a bitstream conforming to a particular standard or more than one standard. For example, video decoder 30 may impose the temporal motion vector prediction process constraint when decoding a bitstream that conforms to HLS-only HSVC coding. In another example, video decoder 30 may impose the temporal motion vector prediction process constraint when decoding a bitstream that conforms to multiple standards, such as an H.264/AVC base layer and an HEVC enhancement layer.

In some examples, according to aspects of this disclosure, entropy decoding unit 70 may obtain, from an encoded bitstream, a collocated_ref_idx syntax element that identifies a co-located reference picture that is included in the same layer as the current picture. In such examples, entropy decoding unit 70 may ignore or discard a collocated_ref_idx syntax element identifying a co-located reference picture in a layer other than the layer currently being coded.

In some examples, prior to determining a TMVP, video decoder 30 may determine whether to enable the temporal motion vector prediction process based on one or more conditions. If the temporal motion vector prediction process is not enabled, video decoder 30 may not determine or include a TMVP in a merge mode or AMVP candidate list, and a TMVP will not be used to decode a motion vector for a block currently being coded.

In one example, video decoder 30 may disable the temporal motion vector prediction process from being performed based on the reference pictures identified in a slice header of the slice currently being encoded. For example, video decoder 30 may disable temporal motion vector prediction for slices being decoded that do not include any reference pictures in a reference picture list that belong to the same layer as the slices being coded. Video decoder 30 may automatically impose this constraint, or may impose the constraint based on one or more syntax element obtained and decoded from an encoded bitstream. For example, entropy decoding unit 70 may disable the temporal motion vector prediction process upon decoding a slice_temporal_mvp_enable_flag syntax element that is equal to zero.

In another example, according to aspects of this disclosure, video decoder 30 may disable the temporal motion vector prediction process from being performed based on the type of picture being encoded. For example, video decoder 30 may disable the temporal motion vector prediction process when the picture currently being coded is a random access picture (as described in greater detail, for example, with respect to FIG. 7 below). Again, video decoder 30 may automatically impose this constraint, or may disable the temporal motion vector prediction process upon decoding a slice_temporal_mvp_enable_flag syntax element that is equal to zero.

Motion compensation unit 72 may use the decoded motion vectors (including motion vectors decoded relative to a motion vector predictor) to retrieve data from a previously decoded picture, e.g., from reference picture memory 82. Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

In this manner, video decoder 30 of FIG. 3 represents an example of a video decoder configured to determine a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor, and restrict the temporal motion vector prediction process such that the co-located picture used to derive the temporal motion vector predictor is not located in a layer other than the first layer of the plurality of layers of video data.

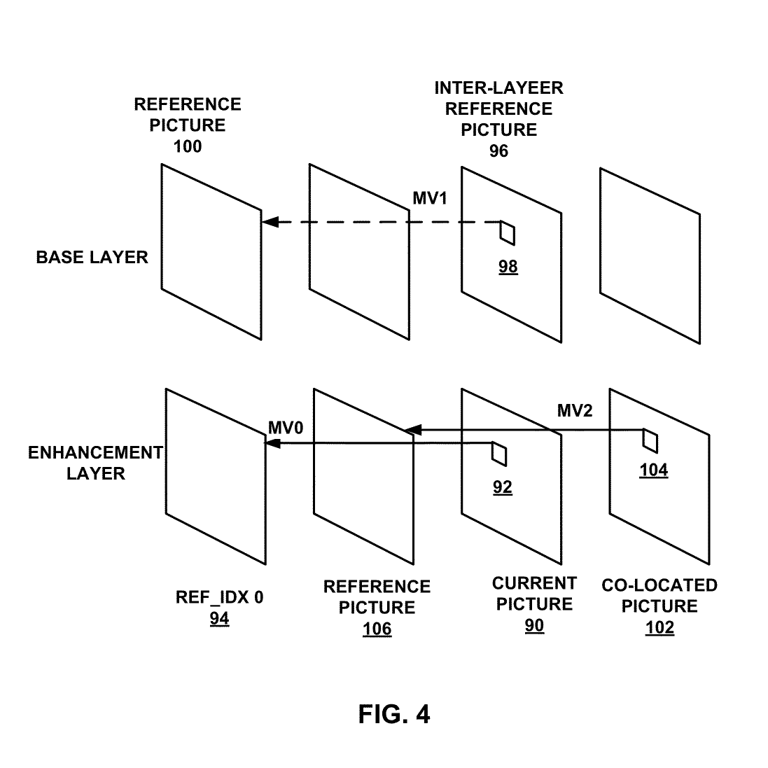

FIG. 4 is a conceptual diagram illustrating a process for determining a TMVP. The example shown in FIG. 4 includes a picture currently being coded (“current picture”) 90 having a block currently being coded 92 and corresponding motion vector (MV0) identifying a block of a reference picture having an index of zero in a reference picture list for the current picture (“ref_idx 0”) 94. In addition, the example also includes an inter-layer reference picture 96 having a co-located block 98 and corresponding motion vector (MV1) identifying a block of a reference picture in the base layer 100. The example also includes a co-located reference picture ((“co-located picture”) 102 having a co-located block 104 and a motion vector (MV2) identifying a block of reference picture 106.

Although picture 102 is referred to as a “co-located reference picture,” it should be understood that this is intended to refer to a picture that includes a co-located block for a current block of current picture 90. That is, “co-located reference picture” is used as notational short-hand to refer to a picture including a co-located block for a current block of a current picture, and not necessarily to a picture that is co-located with the current picture. Of course, in some examples, the co-located picture may correspond to an inter-layer reference picture that is indeed temporally co-located with current picture 90.

In any case, to determine a TMVP for current block 92 of current picture 90, a video coder (such as video encoder 20 or video decoder 30) may first determine whether there are any temporal motion vector prediction process restrictions. For example, according to aspects of this disclosure, the video coder may be restricted from identifying a co-located picture (e.g., associated with collocated_ref_idx) that belongs to a layer other than the layer currently being coded, i.e., the enhancement layer. Accordingly, despite inter-layer reference picture 96 being included in a reference picture list for coding current picture 90, the motion vector MV1 associated with block 98 of inter-layer reference picture 96 may not be used as a motion vector predictor of MV0 associated with block 92 of current picture 90. That is, the video coder may not add motion vector MV 1 to a motion vector predictor candidate list for predicting motion vector MV0. Motion vector MV1 is shown in the example of FIG. 4 using a dashed line to indicate that it is not available for motion vector prediction.

While the video coder may not consider motion vector MV1 for predicting motion vector MV0, the video coder may identify a co-located picture in the same layer as the current picture 90. Accordingly, in the example shown in FIG. 4, the video coder identifies co-located picture 102 having block 104 and motion vector MV2. The video coder may identify co-located picture 102 based on a syntax element, e.g., a collocated_from 10 flag signaled in a slice header that indicates whether the co-located picture is from RefPicList0 or RefPicList1. After co-located picture 104 is identified, the video coder identifies the co-located picture in the appropriate reference picture list. The video coder then identifies co-located block 104 by checking co-located picture 102. In this example, the video coder may add motion vector MV2 to a motion vector predictor candidate list for predicting motion vector MV0.

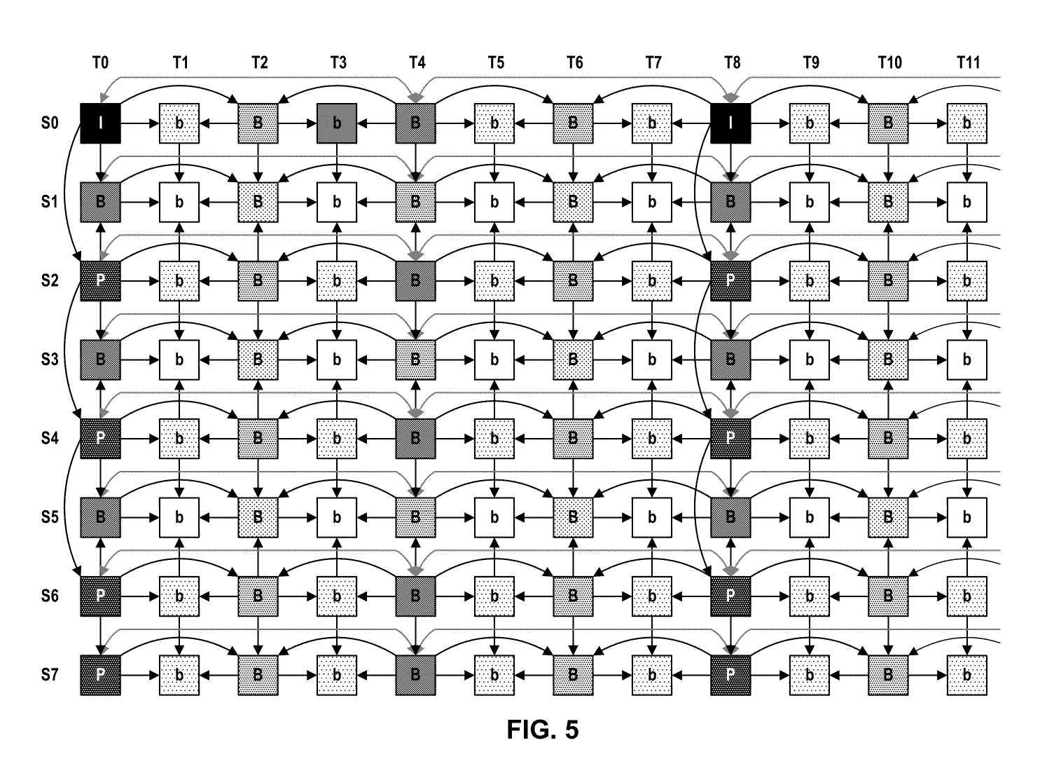

FIG. 5 is a conceptual diagram illustrating an example MVC prediction pattern. While FIG. 5 is described with respect to H.264/AVC and MVC, it should be understood that a similar prediction pattern may be used with other multiview video coding schemes, including MV-HEVC, 3D-HEVC (multiview plus depth), and multiview using scalable video coding including, for example, HSVC. Thus, references to MVC below apply to multiview video coding in general, and are not restricted to H.264/MVC.

In the example of FIG. 5, eight views (having view IDs “S0” through “S7”) are illustrated, and twelve temporal locations (“T0” through “T11”) are illustrated for each view. That is, each row in FIG. 5 corresponds to a view, while each column indicates a temporal location.

Although MVC has a so-called base view which is decodable by H.264/AVC decoders and stereo view pair could be supported also by MVC, the advantage of MVC is that it could support an example that uses more than two views as a 3D video input and decodes this 3D video represented by the multiple views. A renderer of a client having an MVC decoder may expect 3D video content with multiple views.

Pictures in FIG. 5 are indicated at the intersection of each row and each column in FIG. 5 using a shaded block including a letter, designating whether the corresponding picture is intra-coded (that is, an I-frame), or inter-coded in one direction (that is, as a P-frame) or in multiple directions (that is, as a B-frame). In general, predictions are indicated by arrows, where the pointed-to picture uses the point-from object for prediction reference. For example, the P-frame of view S2 at temporal location TO is predicted from the I-frame of view S0 at temporal location T0.

As with single view video encoding, pictures of a multiview video coding video sequence may be predictively encoded with respect to pictures at different temporal locations. For example, the b-frame of view S0 at temporal location T1 has an arrow pointed to it from the I-frame of view S0 at temporal location T0, indicating that the b-frame is predicted from the I-frame. Additionally, however, in the context of multiview video encoding, pictures may be inter-view predicted. That is, a view component can use the view components in other views for reference. In MVC, for example, inter-view prediction is realized as if the view component in another view is an inter-prediction reference. The potential inter-view references are signaled in the Sequence Parameter Set (SPS) MVC extension and can be modified by the reference picture list construction process, which enables flexible ordering of the inter-prediction or inter-view prediction references.

In MVC, inter-view prediction is allowed among pictures in the same access unit (that is, with the same time instance). An access unit is, generally, a unit of data including all view components (e.g., all NAL units) for a common temporal instance. Thus, in MVC, inter-view prediction is permitted among pictures in the same access unit. When coding a picture in one of the non-base views, the picture may be added into a reference picture list, if it is in a different view but with the same time instance (e.g., the same POC value, and thus, in the same access unit). An inter-view prediction reference picture may be put in any position of a reference picture list, just like any inter prediction reference picture.

FIG. 5 provides various examples of inter-view prediction. Pictures of view S1, in the example of FIG. 5, are illustrated as being predicted from pictures at different temporal locations of view S1, as well as inter-view predicted from pictures of views S0 and S2 at the same temporal locations. For example, the b-frame of view S1 at temporal location T1 is predicted from each of the B-frames of view S1 at temporal locations T0 and T2, as well as the b-frames of views S0 and S2 at temporal location T1.

In the example of FIG. 5, capital “B” and lowercase “b” are intended to indicate different hierarchical relationships between pictures, rather than different encoding methodologies. In general, capital “B” pictures are relatively higher in the prediction hierarchy than lowercase “b” pictures. FIG. 5 also illustrates variations in the prediction hierarchy using different levels of shading, where a greater amount of shading (that is, relatively darker) pictures are higher in the prediction hierarchy than those pictures having less shading (that is, relatively lighter). For example, all I-frames in FIG. 5 are illustrated with full shading, while P-frames have a somewhat lighter shading, and B-frames (and lowercase b-frames) have various levels of shading relative to each other, but always lighter than the shading of the P-frames and the I-frames.

In general, the prediction hierarchy is related to view order indexes, in that pictures relatively higher in the prediction hierarchy should be decoded before decoding pictures that are relatively lower in the hierarchy, such that those pictures relatively higher in the hierarchy can be used as reference pictures during decoding of the pictures relatively lower in the hierarchy. A view order index is an index that indicates the decoding order of view components in an access unit. The view order indices are implied in the SPS MVC extension, as specified in Annex H of H.264/AVC (the MVC amendment). In the SPS, for each index i, the corresponding view id is signaled. In some examples, the decoding of the view components shall follow the ascending order of the view order index. If all the views are presented, then the view order indexes are in a consecutive order from 0 to num_views_minus_{—}1.

In this manner, pictures used as reference pictures may be decoded before decoding the pictures that are encoded with reference to the reference pictures. A view order index is an index that indicates the decoding order of view components in an access unit. For each view order index i, the corresponding view id is signaled. The decoding of the view components follows the ascending order of the view order indexes. If all the views are presented, then the set of view order indexes may comprise a consecutively ordered set from zero to one less than the full number of views.

For certain pictures at equal levels of the hierarchy, decoding order may not matter relative to each other. For example, the I-frame of view S0 at temporal location T0 is used as a reference picture for the P-frame of view S2 at temporal location T0, which is in turn used as a reference picture for the P-frame of view S4 at temporal location T0. Accordingly, the I-frame of view S0 at temporal location T0 should be decoded before the P-frame of view S2 at temporal location T0, which should be decoded before the P-frame of view S4 at temporal location T0. However, between views S1 and S3, a decoding order does not matter, because views S1 and S3 do not rely on each other for prediction, but instead are predicted only from views that are higher in the prediction hierarchy. Moreover, view S1 may be decoded before view S4, so long as view S1 is decoded after views S0 and S2.

In this manner, a hierarchical ordering may be used to describe views S0 through S7. Let the notation SA>SB mean that view SA should be decoded before view SB. Using this notation, S0>S2>S4>S6>S7, in the example of FIG. 5. Also, with respect to the example of FIG. 5, S0>S1, S2>S1, S2>S3, S4>S3, S4>S5, and S6>S5. Any decoding order for the views that does not violate these requirements is possible. Accordingly, many different decoding orders are possible.

In some instances, the multiview structure and prediction relationships shown in FIG. 5 may be implemented using scalable layers of video data, as described below with respect to FIG. 5.

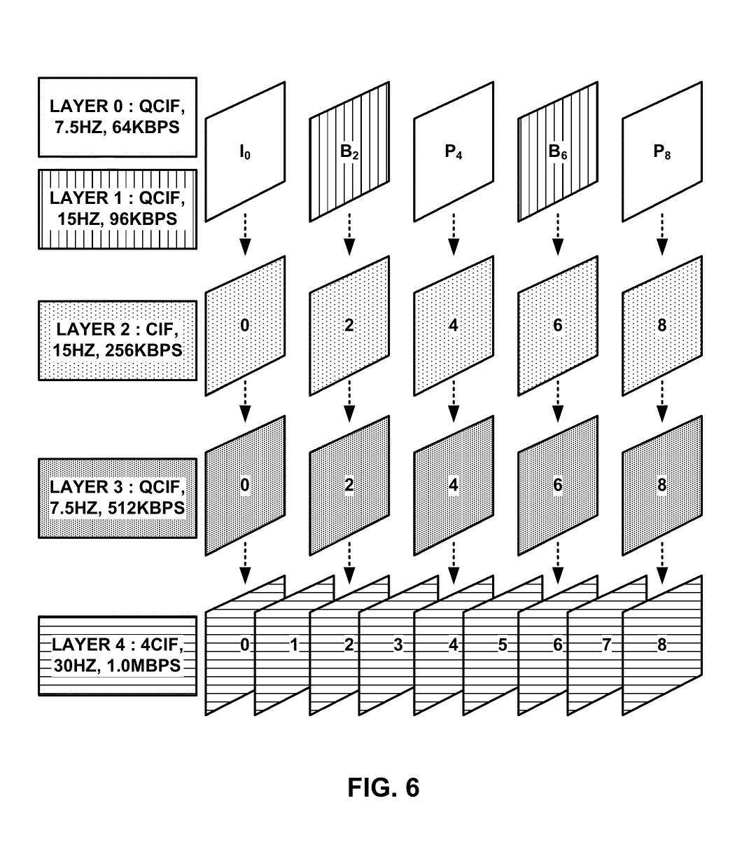

FIG. 6 is a conceptual diagram illustrating scalable video coding. While FIG. 6 is described with respect to H.264/AVC and SVC, it should be understood that similar layers may be coded suing other multilayer video coding schemes, including HSVC. In another example, similar layers may be coded using a multi-standard codec. For example, a base layer may be coded using H.264/AVC, while an enhancement layer may be coded using a scalable, HLS-only extension to HEVC. Thus, references to SVC below may apply to scalable video coding in general, and are not restricted to H.264/SVC.

In SVC, scalabilities may be enabled in three dimensions including, for example, spatial, temporal, and quality (represented as a bit rate or signal to noise ratio (SNR)). In general, better representation can be normally achieved by adding to a representation in any dimension. For example, in the example of FIG. 6, layer 0 is coded at Quarter Common Intermediate Format (QCIF) having a frame rate of 7.5 Hz and a bit rate of 64 kilobytes per second (KBPS). In addition, layer 1 is coded at QCIF having a frame rate of 15 Hz and a bit rate of 64 KBPS, layer 2 is coded at CIF having a frame rate of 15 Hz and a bit rate of 256 KBPS, layer 3 is coded at QCIF having a frame rate of 7.5 Hz and a bit rate of 512 KBPS, and layer 4 is coded at 4CIF having a frame rate of 30 Hz and a bit rate of Megabyte per second (MBPS). It should be understood that the particular number, contents and arrangement of the layers shown in FIG. 6 are provided for purposes of example only.

In any case, once a video encoder (such as video encoder 20) has encoded content in such a scalable way, a video decoder (such as video decoder 30) may use an extractor tool to adapt the actual delivered content according to application requirements, which may be dependent e.g., on the client or the transmission channel.

In SVC, pictures having the lowest spatial and quality layer are typically compatible with H.264/AVC. In the example of FIG. 6, pictures with the lowest spatial and quality layer (pictures in layer 0 and layer 1, with QCIF resolution) may be compatible with H.264/AVC. Among them, those pictures of the lowest temporal level form the temporal base layer (layer 0). This temporal base layer (layer 0) may be enhanced with pictures of higher temporal levels (layer 1).

In addition to the H.264/AVC compatible layer, several spatial and/or quality enhancement layers may be added to provide spatial and/or quality scalabilities. Each spatial or quality enhancement layer itself may be temporally scalable, with the same temporal scalability structure as the H.264/AVC compatible layer. In some instances, as noted above, enhancement layers may be coded based on a different coding standard, such as HEVC. That is, for example, in both the SVC and the MVC/3DV context, it is possible to code a base layer with a codec that is different from HEVC, e.g., H.264/AVC, while coding one or more enhancement layers with HEVC.

In an HLS-only HEVC process, if two spatial layers have the same spatial resolution, a video coder (such as video encoder 20 or video decoder 30) may perform motion vector prediction in a manner similar to MV-HEVC (using the prediction structure as shown and described with respect to FIG. 5). In this example, the video coder may determine a TMVP, even when the co-located picture is from a different view than the view currently being coded. That is, as noted above, the video coder may add a picture from a different view to a reference picture list, and the video coder may select the picture as a co-located picture for determining a TMVP.

However, as noted above, in some instances, the motion field of one of the layers may not be available for coding another layer. As an example, when a base layer (e.g., layer 0) and an enhancement layer (e.g., layer 2) have different resolutions, the video coder may not be able to properly access the motion field of the base layer to determine a TMVP for predicting a motion vector in the enhancement layer. As another example, when a base layer (e.g., layer 0) and an enhancement layer (e.g., layer 2) are coded with different video coding standards, the video coder may not be able to properly access the motion field of the base layer to determine a TMVP for predicting a motion vector in the enhancement layer.

According to aspects of this disclosure, a video coder (such as video encoder 20 or video decoder 30) may restrict a temporal motion vector prediction process by imposing one or more constraints on the temporal motion vector prediction process. For example, the video coder may be restricted from selecting a co-located picture for a TMVP that does not belong to the same layer as the picture currently being coded.

In an example for purposes of illustration, assume that the video coder is coding a motion vector associated with a block included in a picture of layer 4. In this example, the when determining a TMVP for predicting the motion vector of layer 4, the video coder may not identify a co-located picture in any layer but layer 4. That is, the video coder may be restricted from coding the current motion vector relative to a motion vector associated with a block in a different layer. In this example, the video coder may still determine a TMVP associated with a co-located picture in layer 4, and may add the TMVP to a motion vector predictor candidate list for predicting the motion vector in layer 4.

In some examples, prior to determining the TMVP, the video coder may preliminarily determine whether to carry out the temporal motion vector prediction process. For example, according to aspects of this disclosure, the video coder may initially determine whether to carry out the temporal motion vector prediction process for determining a TMVP based on the reference pictures of the slice currently being coded.

For example, with respect to the example described above, the video coder may determine whether any of the reference pictures signaled in the slice header for the block in layer 4 are included in layer 4. If none of the reference pictures are included in layer 4, there are no reference pictures that satisfy the condition that the co-located reference picture be included in the same layer as the picture currently being coded. Accordingly, the video coder may disable the temporal motion vector prediction process, such that a TMVP is not determined. In this example, the video coder may select a different motion vector predictor candidate, e.g., from a motion vector predictor candidate list. In this way, temporal motion vector prediction can be enabled or disabled on a slice-by-slice basis.

FIG. 7 is a conceptual diagram illustrating an example clean random access (CRA) picture and example leading pictures. For example, in HEVC, in general, there are four picture types that can be identified by the NAL unit type. The four picture types include an instantaneous decoding refresh (IDR) picture, a CRA picture, a temporal layer access (TLA) picture and a coded picture that is not an IDR, CRA or TLA picture. The IDR and the coded pictures are picture types inherited from the H.264/AVC specification. The CRA and the TLA picture types are new additions for the HEVC standard. A CRA picture is a picture type that facilitates decoding beginning from any random access point in the middle of a video sequence, and may be more efficient than inserting IDR pictures. A TLA picture is a picture type that can be used to indicate valid temporal layer switching points.

In video applications, such as broadcasting and streaming, switching may occur between different channels of video data and jumping may occur to specific parts of video data. In such instances, it may be beneficial to achieve minimum delay during switching and/or jumping. This feature is enabled by having random access pictures at regular intervals in the video bitstreams. The IDR picture, specified in both H.264/AVC and HEVC may be used for random access. However, an IDR picture starts a coded video sequence and removes pictures from a decoded picture buffer (DPB) (which may also be referred to as a reference picture memory, as described above with respect to FIGS. 2 and 3). Accordingly, pictures following the IDR picture in decoding order cannot use pictures decoded prior to the IDR picture as a reference. Consequently, bitstreams relying on IDR pictures for random access may have significantly lower coding efficiency (e.g., by approximately 6% versus bitstreams relying on other random access pictures, such as CRA pictures). To improve the coding efficiency, CRA pictures in HEVC allow pictures that follow a CRA picture in decoding order but precede the CRA picture in output order to use pictures decoded before the CRA picture as a reference.

A typical prediction structure around a CRA picture is shown in FIG. 7, where the CRA picture (with POC 24 and denoted as CRA picture 160) belongs to a Group of Pictures (GOP) 162, which contains other pictures (POC 17 through 23) 164, following CRA picture 160 in decoding order but preceding CRA picture 160 in output order. These pictures are called leading pictures 164 of CRA picture 160 and can be correctly decoded if the decoding starts from an IDR or CRA picture before current CRA picture 160. However, leading pictures may not be correctly decoded when random access from this CRA picture 160 occurs. As a result, these leading pictures are typically discarded during the random access decoding.

To prevent error propagation from reference pictures that may not be available depending on where the decoding starts, all pictures in the next GOP 166 as shown in FIG. 7, that follow CRA picture 160 both in decoding order and output order, should not use any picture that precedes CRA picture 160 either in decoding order or output order (which includes the leading pictures) as reference.

Similar random access functionalities are supported in H.264/AVC with the recovery point SEI message. An H.264/AVC decoder implementation may or may not support the functionality. In HEVC, a bitstream starting with a CRA picture is considered a conforming bitstream. When a bitstream starts with a CRA picture, the leading pictures of the CRA picture may refer to unavailable reference pictures and therefore may not be correctly decoded. However, HEVC specifies that the leading pictures of the starting CRA picture are not output, hence the name “clean random access.” For establishment of bitstream conformance requirement, HEVC specifies a decoding process to generate unavailable reference pictures for decoding of the non-output leading pictures. However, conforming decoder implementations do not have to follow that decoding process, as long as these conforming decoders can generate identical output compared to when the decoding process is performed from the beginning of the bitstream. In HEVC, a conforming bitstream may contain no IDR pictures at all, and consequently may contain a subset of a coded video sequence or an incomplete coded video sequence.

Besides the IDR and CRA pictures, there are other types of random access point pictures, e.g., a broken link access (BLA) picture. For each of the major types of the random access point pictures, there may be sub-types, depending on how a random access point picture could be potentially treated by systems. Each sub-type of random access point picture has a different NAL unit type.

With respect to extensions of HEVC, such as MV-HEVC or HSVC, a bitstream may be formed such that no coding unit level or lower level changes are required for implementation of MV-HEVC. The concept of random access in HEVC may be extended and applied to extensions of HEVC. Detailed definitions of random access point access units, as well as random access view components are included in the MV-HEVC working draft specification: JCT3V-A1004, entitled “MV-HEVC Working Draft 1,” JCT3V-A1004, Joint Collaborative Team on 3D Video Coding Extension Development of ITU-T SG 16 WP 3 and ISO/IEC JTC 1/SC 29/WG 11, 1st Meeting: Stockholm, SE, 16-20 Jul. 2012 and available at http://phenix.it-sudparis.eu/jct2/doc_end_user/documents/1 Stockholm/wg11/JCT3V-A1004-v1.zip.

In general, with respect to a multiview extension of HEVC, whether a view component is a random access point may depend on the NAL unit type of the view component. If the type belongs to those defined in HEVC base specification for random access point pictures, the current view component is a random access point view component (or, for simplicity, random access point picture of the current view).

In some instances, the random access functionality only applies to temporal prediction in a way that certain predictions in the temporal dimension (thus inside a view) is either disabled or constrained similarly as in HEVC base specification. However, inter-view prediction for a random access point view component is still possible, and generally performed to improve coding efficiency, similar to the anchor picture in H.264/MVC. Thus, a random access point (RAP) view component, if using inter-view prediction, may be a P or B picture. In some instances, this above noted concept can be extended to the scalable extension of HEVC or “toward HEVC” multi-standard codec, described below.

With respect to an inter-view reference picture list, a video coder (such as video encoder 20 or video decoder 30) may create an inter-view reference picture based on the view dependency signaled in the video parameter set (VPS). For a current picture, pictures that are in the same access unit and belong to the dependent views (signaled in VPS) may form an inter-view reference picture list. A picture in an inter-view reference picture list may be added into a reference picture list of the current picture.

In HLS-only HEVC, when the two spatial layers have the same spatial resolution, inter-view prediction can be supported similar to MV-HEVC, where a TMVP may be determined from a co-located picture, even when the co-located picture is from a different view. However, in an HLS-only scalable HEVC codec, there should be no changes equal or below the coding unit level. That is, syntax changes may only be allowed in, for example, a slice header, a sequence parameter set (SPS), a picture parameter set (PPS), a view parameter set (VPS), a network abstraction layer (NAL) unit header, or a supplemental enhancement information (SEI) message. A conforming bitstream must adhere to the lower-level structure defined by HEVC.

Typically, in such a codec (video encoder/decoder), a base layer picture may be inserted into a reference picture list and may be used as a reference picture, in some instances, after upsampling the base layer picture. This process may be similar to an inter-view reference picture in MV-HEVC. Furthermore, multiple representations of the base layer pictures, e.g., generated with different (upsampling) filters, may be added into the same reference picture list.

If a picture in an access unit is a random access picture, typically all of the pictures in the access unit (all layers of the picture) are random access pictures. Due to the potential inclusion of inter-layer reference pictures associated with a random access picture in a reference picture list for the random access picture, a video coder may attempt to determine a TMVP using an inter-layer reference picture. However, random access inter-layer reference pictures to not include a temporal motion field (e.g., blocks of such pictures are intra-coded or inter-layer coded). Accordingly, a TMVP, which relies on a temporal motion field to predict a motion information of the current block, may not be properly attained from a random access inter-layer reference picture.

According to aspects of this disclosure, a temporal motion vector prediction process may be enabled or disabled based on when the current picture is a random access picture. For example, prior to determining a TMVP, the video coder may determine whether the picture currently being coded is a random access picture, including, for example, an IDR, CRA, or BLA picture. If the picture is a random access picture, the video coder may disable the temporal motion vector prediction process, and may not determine a TMVP for inclusion in a temporal motion vector candidate list. Such a technique may be used to avoid encountering a situation in which a TMVP may not be properly attained for a random access picture, as noted above.

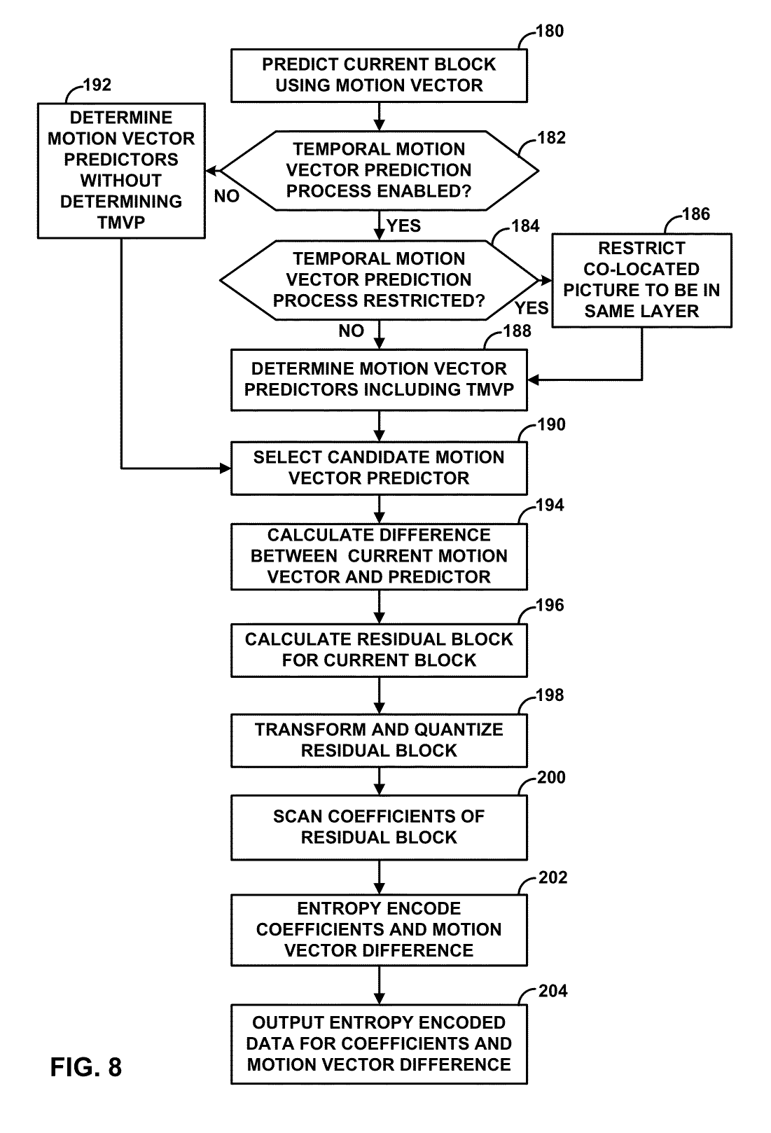

FIG. 8 is a flowchart illustrating an example method for encoding a current block in accordance with the techniques of this disclosure. The current block may comprise a current CU or a portion of the current CU, e.g., a current PU. Although described with respect to video encoder 20 (FIGS. 1 and 2), it should be understood that other devices may be configured to perform a method similar to that of FIG. 8.

In this example, video encoder 20 initially predicts the current block (180). For example, video encoder 20 may calculate one or more prediction units (PUs) for the current block. In this example, it is assumed that video encoder 20 inter-predicts the current block. For example, motion estimation unit 42 may calculate a motion vector for the current block by performing a motion search of previously coded pictures, e.g., inter-view pictures and temporal pictures. Thus, motion estimation unit 42 may produce a temporal motion vector or a disparity motion vector to encode the current block.

In some instances, video encoder 20 may predict the motion vector for the current block. In such instances, video encoder 20 may determine whether a temporal motion vector prediction process is enabled (182). The temporal motion vector prediction process may enable video encoder 20 to determine a TMVP for predicting the motion vector of the current block.

If the temporal motion vector prediction process is enabled (the YES branch of step 182), video encoder 20 may determine whether the temporal motion vector prediction process is restricted (184). According to aspects of this disclosure, entropy encoding unit 56 determine whether to apply a temporal motion vector prediction process restriction based on whether the block currently being coded is included in multilayer video data, e.g., as scalable video data and/or video data coded with multiple coding standards. Entropy encoding unit 56 may apply a temporal motion vector prediction process restriction any time the block currently being coded is included in such multilayer video data.

If the temporal motion vector prediction process is restricted, entropy encoding unit 56 may be restricted from identifying a co-located picture for determining a TMVP from being included in any layer other than the layer currently being coded (186). Entropy encoding unit 56 may then determine motion vector predictors including a TMVP from a co-located picture in the layer currently being encoded (188). After forming the list of candidate motion vector predictors, entropy encoding unit 56 selects one of the candidate motion vector predictors to use as a motion vector predictor for the current motion vector (190).

Returning to step 182, if the temporal motion vector prediction process is not enabled (the NO branch of step 182), entropy encoding unit 56 may determine motion vector predictors without determining a TMVP (192). As noted above, video encoder 20 may disable the temporal motion vector prediction process when there are no reference pictures in a reference picture list for the current block that are included in the same layer as the current block. Additionally or alternatively, video encoder 20 may disable the temporal motion vector prediction process when the current block is included in a random access picture.

In any case, after forming the list of candidate motion vector predictors (with or without a TMVP), entropy encoding unit 56 selects one of the candidate motion vector predictors to use as a motion vector predictor for the current motion vector (190). Entropy encoding unit 56 then calculates the difference between the current motion vector and the selected (and potentially scaled) motion vector predictor (194).

Video encoder 20 may then calculate a residual block for the current block, e.g., to produce a transform unit (TU) (196). To calculate the residual block, video encoder 20 may calculate a difference between the original, uncoded block and the predicted block for the current block. Video encoder 20 may then transform and quantize coefficients of the residual block (198). Next, video encoder 20 may scan the quantized transform coefficients of the residual block (200). During the scan, or following the scan, video encoder 20 may entropy encode the coefficients (202). For example, video encoder 20 may encode the coefficients using CAVLC or CABAC. Video encoder 20 may then output the entropy coded data of the block (204).

In this manner, the method of FIG. 8 represents an example of a method for encoding video data, the method including determining a temporal motion vector predictor for a motion vector associated with a block of video data of a current picture of a first, non-base layer of a plurality of layers of video data using a temporal motion vector prediction process, where the temporal motion vector prediction process includes identifying a co-located picture from which to derive the temporal motion vector predictor, and restricting the temporal motion vector prediction process such that the co-located picture used to derive the temporal motion vector predictor is not located in a layer other than the first layer of the plurality of layers of video data.

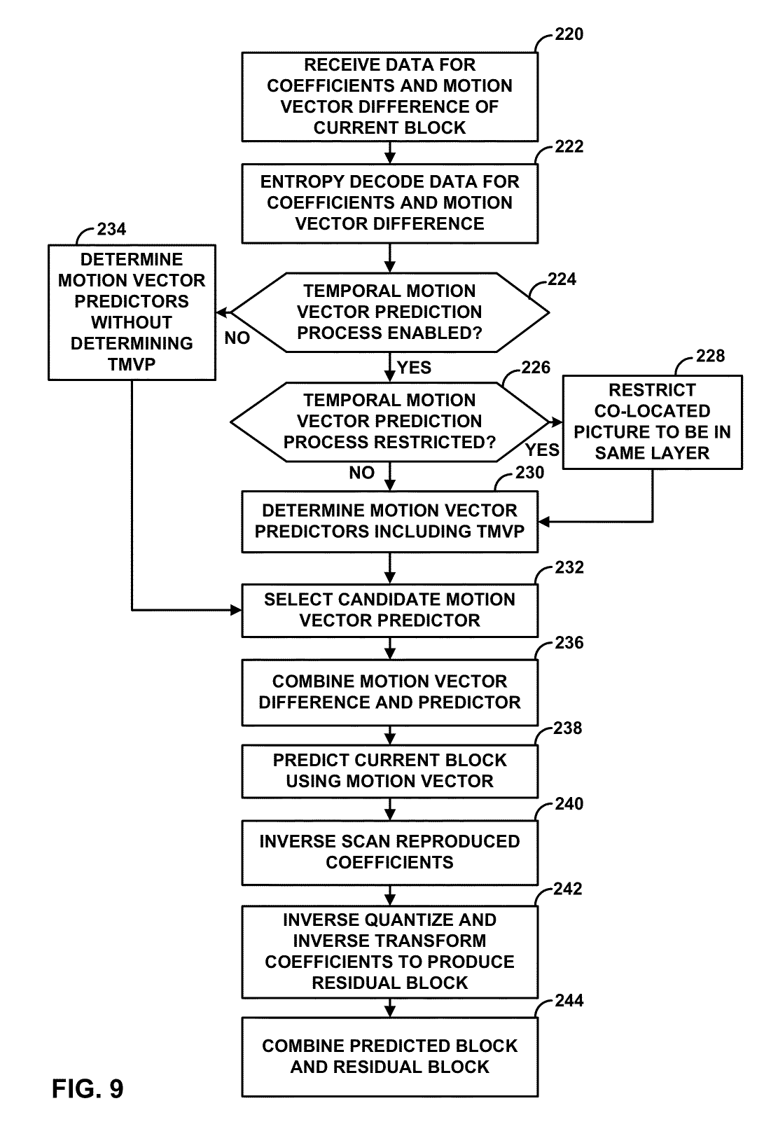

FIG. 9 is a flowchart illustrating an example method for decoding a current block of video data in accordance with the techniques of this disclosure. The current block may comprise a current CU or a portion of the current CU (e.g., a PU). Although described with respect to video decoder 30 (FIGS. 1 and 3), it should be understood that other devices may be configured to perform a method similar to that of FIG. 9.

Initially, video decoder 30 receives data for transform coefficients and motion vector difference values of the current block (220). Entropy decoding unit 70 entropy decodes the data for the coefficients and the motion vector difference values (222).

Video decoder 30 may determine whether a temporal motion vector prediction process is enabled (224). The temporal motion vector prediction process may enable video decoder 30 to determine a TMVP for predicting the motion vector of the current block.

If the temporal motion vector prediction process is enabled (the YES branch of step 224), video decoder 30 may determine whether the temporal motion vector prediction process is restricted (226). According to aspects of this disclosure, entropy decoding unit 70 determine whether to apply a temporal motion vector prediction process restriction based on whether the block currently being coded is included in multilayer video data, e.g., as scalable video data and/or video data coded with multiple coding standards. Entropy decoding unit 70 may apply a temporal motion vector prediction process restriction any time the block currently being coded is included in such multilayer video data.

If the temporal motion vector prediction process is restricted, entropy decoding unit 70 may be restricted from identifying a co-located picture for determining a TMVP from being included in any layer other than the layer currently being coded (228). Entropy decoding unit 70 may then determine motion vector predictors including a TMVP from a co-located picture in the layer currently being encoded (230). entropy decoding unit 70 may determine the co-located picture based on, for example, one or more syntax elements indicating a reference picture list (e.g., list 0 or list 1) and an index to the reference picture list.

After forming the list of candidate motion vector predictors, entropy decoding unit 70 selects one of the candidate motion vector predictors to use as a motion vector predictor for the current motion vector (232). In some examples, entropy decoding unit 70 selects the motion vector predictor according to an implicit, predefined process, whereas in other examples, entropy decoding unit 70 decodes a syntax element indicative of which of the list of candidate motion vectors to select.

Returning to step 224, if the temporal motion vector prediction process is not enabled (the NO branch of step 224), entropy decoding unit 70 may determine motion vector predictors without determining a TMVP (234). As noted above, video decoder 30 may disable the temporal motion vector prediction process when there are no reference pictures in a reference picture list for the current block that are included in the same layer as the current block. Additionally or alternatively, video decoder 30 may disable the temporal motion vector prediction process when the current block is included in a random access picture. In some examples, entropy decoding unit 70 may receive one or more syntax elements indicating whether the temporal motion vector prediction process is enabled (e.g., slice_temporal_mvp_enable_flag).

In any case, after forming the list of candidate motion vector predictors (with or without a TMVP), entropy decoding unit 70 selects one of the candidate motion vector predictors to use as a motion vector predictor for the current motion vector (232). As noted above, in some examples, entropy decoding unit 70 selects the motion vector predictor according to an implicit, predefined process, whereas in other examples, entropy decoding unit 70 decodes a syntax element indicative of which of the list of candidate motion vectors to select.

Entropy decoding unit 70 then mathematically combines the decoded motion vector difference values with the motion vector predictor to reproduce the current motion vector (236). For example, entropy decoding unit 70 may add the x-component of the motion vector difference (MVDx) to the x-component of the selected motion vector predictor, and the y-component of the motion vector difference (MVDy) to the y-component of the selected motion vector predictor.

Video decoder 30 may predict the current block using the decoded motion vector (238). Video decoder 30 may then inverse scan the reproduced coefficients (240), to create a block of quantized transform coefficients. Video decoder 30 may then inverse quantize and inverse transform the coefficients to produce a residual block (242). Video decoder 30 may ultimately decode the current block by combining the predicted block and the residual block (244).

In this manner, the method of FIG. 9 represents an example of a method of decoding video data, the method including determining a temporal motion vector predictor for a motion vector associated with a block of video data of a current picture of a first, non-base layer of a plurality of layers of video data using a temporal motion vector prediction process, where the temporal motion vector prediction process includes identifying a co-located picture from which to derive the temporal motion vector predictor, and restricting the temporal motion vector prediction process such that the co-located picture used to derive the temporal motion vector predictor is not located in a layer other than the first layer of the plurality of layers of video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Certain aspects of this disclosure have been described with respect to the developing HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding multi-layer video data comprising a plurality of layers of video data, the method comprising:
determining a temporal motion vector predictor for a motion vector associated with a block of video data of a current picture of a first, non-base layer of the plurality of layers of video data using a temporal motion vector prediction process, wherein the temporal motion vector prediction process includes identifying a co-located picture from which to derive the temporal motion vector predictor; and
restricting the temporal motion vector prediction process such that the co-located picture used to derive the temporal motion vector predictor is not located in a layer other than the first layer of the plurality of layers of video data.

2. The method of claim 1, wherein the first, non-base layer and the layer other than the first layer comprise scalable video coding layers and the first, non-base layer is a scalable video coding enhancement layer.

3. The method of claim 2, wherein the scalable video coding enhancement layer comprises coded video data conforming to a high level syntax—only High Efficiency Video Coding standard, which comprises an ability to decode the coded video data without block level changes to the High Efficiency Video Coding standard.

4. The method of claim 2, wherein the layer other than the first layer is a scalable video coding base layer.

5. The method of claim 1, wherein restricting the temporal motion vector prediction process further comprises:
prior to restricting the temporal motion vector prediction process, determining whether the first, non-base layer and the layer other than the first, non-base layer conform to the same video coding standard;
determining whether to restrict the temporal motion vector prediction process based on whether the first, non-base layer and the layer other than the first layer conform to the same video coding standard; and
restricting the temporal motion vector prediction process when the first, non-base layer and the layer other than the first layer conform to different video coding standards.

6. The method of claim 1, wherein restricting the temporal motion vector prediction process further comprises:
obtaining, from an encoded bitstream, a co-located reference picture index value of the co-located picture for the temporal motion vector predictor that identifies a picture in the first layer.

7. The method of claim 1, further comprising:
prior to determining the temporal motion vector predictor, determining whether the current picture is a random access picture; and
disabling the temporal motion vector prediction process when the current picture is a random access picture, such that determining the temporal motion vector predictor is not performed.

8. The method of claim 7, wherein determining whether the temporal motion vector prediction process is enabled comprises obtaining data indicative of a slice_temporal_mvp_enable_flag syntax element from an encoded bitstream.

9. The method of claim 1, further comprising:
prior to determining the temporal motion vector predictor, determining whether a slice of the current picture including the block of video data includes at least one reference picture in the first layer; and
disabling the temporal motion vector prediction process when the slice including the block of video data does not include at least one reference picture in the first layer.

10. The method of claim 9, wherein determining whether the temporal motion vector prediction process is enabled comprises obtaining data indicative of a slice_temporal_mvp_enable_flag syntax element from an encoded bitstream.

11. The method of claim 1, further comprising:
prior to restricting the temporal motion vector prediction process, determining whether the temporal motion vector prediction process is enabled for pictures of the first, non-base layer; and
restricting the temporal motion vector prediction process when the temporal motion vector prediction process is disabled for pictures of the first, non-base layer.

12. A method for decoding multi-layer video data comprising a plurality of layers of video data, the method comprising:
determining a temporal motion vector predictor for a motion vector associated with a block of video data of a current picture of a first, non-base layer of the plurality of layers of video data using a temporal motion vector prediction process, wherein the temporal motion vector prediction process includes identifying a co-located picture from which to derive the temporal motion vector predictor; and
restricting the temporal motion vector prediction process such that the co-located picture used to derive the temporal motion vector predictor is not located in a layer other than the first layer of the plurality of layers of video data.

13. The method of claim 12, wherein the first, non-base layer and the layer other than the first layer comprise scalable video coding layers and the first, non-base layer is a scalable video coding enhancement layer.

14. The method of claim 13, wherein the scalable video coding enhancement layer comprises coded video data conforming to a high level syntax—only High Efficiency Video Coding standard, which comprises an ability to encode the coded video data without block level changes to the High Efficiency Video Coding standard.

15. The method of claim 13, wherein the layer other than the first layer is a scalable video coding base layer.

16. The method of claim 12, wherein restricting the temporal motion vector prediction process further comprises:
prior to restricting the temporal motion vector prediction process, determining whether the first, non-base layer and the layer other than the first, non-base layer conform to the same video coding standard;
determining whether to restrict the temporal motion vector prediction process based on whether the first, non-base layer and the layer other than the first layer conform to the same video coding standard; and
restricting the temporal motion vector prediction process when the first, non-base layer and the layer other than the first layer conform to different video coding standards.

17. The method of claim 12, wherein restricting the temporal motion vector prediction process further comprises:
including data indicating a co-located reference picture index value of the co-located picture for the temporal motion vector predictor that identifies a picture in the first layer in an encoded bitstream.

18. The method of claim 12, further comprising:
prior to determining the temporal motion vector predictor, determining whether the current picture is a random access picture; and
disabling the temporal motion vector prediction process when the current picture is a random access picture, such that determining the temporal motion vector predictor is not performed.

19. The method of claim 18, further comprising:
including a slice_temporal_mvp_enable_flag syntax element in an encoded bitstream to indicate whether the temporal motion vector prediction process is enabled.

20. The method of claim 12, further comprising:
prior to determining the temporal motion vector predictor, determining whether a slice of the current picture including the block of video data includes at least one reference picture in the first layer; and
disabling the temporal motion vector prediction process when the slice including the block of video data does not include at least one reference picture in the first layer.

21. The method of claim 20, further comprising:
including a slice_temporal_mvp_enable_flag syntax element in an encoded bitstream to indicate whether the temporal motion vector prediction process is enabled.

22. The method of claim 12, further comprising:
prior to restricting the temporal motion vector prediction process, determining whether the temporal motion vector prediction process is enabled for pictures of the first, non-base layer; and
restricting the temporal motion vector prediction process when the temporal motion vector prediction process is disabled for the first, non-base layer.

23. A device for coding multi-layer video data comprising a plurality of layers of video data, the device comprising a video coder configured to:
determine a temporal motion vector predictor for a motion vector associated with a block of video data of a current picture of a first, non-base layer of the plurality of layers of video data using a temporal motion vector prediction process, wherein the temporal motion vector prediction process includes identifying a co-located picture from which to derive the temporal motion vector predictor; and
restrict the temporal motion vector prediction process such that the co-located picture used to derive the temporal motion vector predictor is not located in a layer other than the first layer of the plurality of layers of video data.

24. The device of claim 23, wherein the first, non-base layer and the layer other than the first layer comprise scalable video coding layers and the first, non-base layer is a scalable video coding enhancement layer.

25. The device of claim 24, wherein the scalable video coding enhancement layer comprises coded video data conforming to a high level syntax—only High Efficiency Video Coding standard, and further comprising decoding the coded video data without block level changes to the High Efficiency Video Coding standard.

26. The device of claim 23, wherein to restricting the temporal motion vector prediction process, the video coder is further configured to:
prior to restricting the temporal motion vector prediction process, determine whether the first, non-base layer and the layer other than the first, non-base layer conform to the same video coding standard;
determine whether to restrict the temporal motion vector prediction process based on whether the first, non-base layer and the layer other than the first layer conform to the same video coding standard; and
restrict the temporal motion vector prediction process when the first, non-base layer and the layer other than the first layer conform to different video coding standards.

27. The device of claim 23, wherein the video coder is further configured to:
prior to determining the temporal motion vector predictor, determine whether a slice of the current picture including the block of video data includes at least one reference picture in the first layer; and
disable the temporal motion vector prediction process when the slice including the block of video data does not include at least one reference picture in the first layer.

28. A device for coding multi-layer video data comprising a plurality of layers of video data, the device comprising:
means for determining a temporal motion vector predictor for a motion vector associated with a block of video data of a current picture of a first, non-base layer of the plurality of layers of video data using a temporal motion vector prediction process, wherein the temporal motion vector prediction process includes identifying a co-located picture from which to derive the temporal motion vector predictor; and
means for restricting the temporal motion vector prediction process such that the co-located picture used to derive the temporal motion vector predictor is not located in a layer other than the first layer of the plurality of layers of video data.

29. The device of claim 28, wherein the means for restricting the temporal motion vector prediction process further comprises:
means for determining whether the first, non-base layer and the layer other than the first, non-base layer conform to the same video coding standard prior to restricting the temporal motion vector prediction process;
means for determining whether to restrict the temporal motion vector prediction process based on whether the first, non-base layer and the layer other than the first layer conform to the same video coding standard; and
means for restricting the temporal motion vector prediction process when the first, non-base layer and the layer other than the first layer conform to different video coding standards.

30. The device of claim 28, further comprising:
means for determining whether a slice of the current picture including the block of video data includes at least one reference picture in the first layer prior to determining the temporal motion vector predictor; and
means for disabling the temporal motion vector prediction process when the slice including the block of video data does not include at least one reference picture in the first layer.

31. A computer-readable storage medium having stored thereon instructions that, when executed, cause a processor of a device for coding video data to:
determine a temporal motion vector predictor for a motion vector associated with a block of video data of a current picture of a first, non-base layer of a plurality of layers of video data using a temporal motion vector prediction process, wherein the temporal motion vector prediction process includes identifying a co-located picture from which to derive the temporal motion vector predictor; and
restrict the temporal motion vector prediction process such that the co-located picture used to derive the temporal motion vector predictor is not located in a layer other than the first layer of the plurality of layers of video data.

32. The computer-readable storage medium of claim 31, wherein the instructions further cause the processor to:
prior to restricting the temporal motion vector prediction process, determine whether the first, non-base layer and the layer other than the first, non-base layer conform to the same video coding standard;
determine whether to restrict the temporal motion vector prediction process based on whether the first, non-base layer and the layer other than the first layer conform to the same video coding standard; and
restrict the temporal motion vector prediction process when the first, non-base layer and the layer other than the first layer conform to different video coding standards.

33. The computer-readable storage medium of claim 31, wherein the instructions further cause the processor to:
determine whether a slice of the current picture including the block of video data includes at least one reference picture in the first layer prior to determining the temporal motion vector predictor; and
disable the temporal motion vector prediction process when the slice including the block of video data does not include at least one reference picture in the first layer.
